(19) United States
(12) Patent Application Publication
(10) Pub. No.: US 2019/0199411 A1
(43) Pub. Date: Jun. 27, 2019

(54) EFFECTIVE SCHEDULING OF TERMINALS IN A WIRELESS COMMUNICATION SYSTEM

(71) Applicant: FUJITSU LIMITED, Kawasaki-shi (JP)

(72) Inventors: Shinya Kumagai, Machida (JP); Teppei Oyama, Kawasaki (JP); Takashi Seyama, Kawasaki (JP)

(73) Assignee: FUJITSU LIMITED, Kawasaki-shi (JP)

(21) Appl. No.: 16/221,527

(22) Filed: Dec. 16, 2018

(30) Foreign Application Priority Data
Dec. 27, 2017 (JP) 2017-251481

(51) Int. Cl. H04B 7/0417; H04B 7/0456; H04B 7/08; H04B 7/06

(52) U.S. Cl. CPC H04B 7/0417; H04B 7/0456; H04B 7/0639; H04B 7/0632; H04B 7/0617; H04B 7/088

(57) ABSTRACT

A base station includes a processor and a plurality of antennas that transmit, to each of terminals, first and second wireless signals to form first and second beams, respectively, and receive, from each terminal, a third wireless signal including feedback information of the terminal in response to the second wireless signal. The processor selects, from among the terminals, based on the feedback information and a correlation value between the first beam and the second beam, a terminal to which the second beam is optimum, as a first terminal that performs communication via the first beam, or selects a terminal as a second terminal that performs communication via the second beam while communication via the first beam is performed in parallel. The plurality of antennas transmit a fourth wireless signal including data to each terminal apparatus to form the first beam or the second beam.

### CROSS-REFERENCE TO RELATED APPLICATION

This application is based upon and claims the benefit of priority of the prior Japanese Patent Application No. 2017-251481, filed on Dec. 27, 2017, the entire contents of which are incorporated herein by reference.

### FIELD

The embodiments discussed herein are related to effective scheduling of terminals in a wireless communication system.

### BACKGROUND

As a technology for implementing ultra wideband transmission in high frequency bands, there is the Massive multi-input multi-output (MIMO) technology. In Massive MIMO, a base station apparatus may perform wireless communication simultaneously with a plurality of terminal apparatuses by spatially multiplexing wireless signals.

However, in Massive MIMO, the number of antenna elements increases from hundreds to thousands in comparison with MIMO. Therefore, in the case where a base station apparatus performs a precoding process (or a digital precoding process), the arithmetic operation amount becomes very great by performing matrix operation of dimensions that increase in proportion to the number of antenna elements.

Therefore, by IEEE (the Institute of Electrical and Electronics Engineers, Inc.), hybrid beam forming (BF) is examined. The hybrid BF is a technology that combines, for example, analog BF and a digital precoding process. The analog BF is a technology that controls, for example, the phase of analog signals to be individually inputted to a plurality of antenna elements to control the directionality of beams. Meanwhile, the digital precoding process is a technology that performs weighting, for example, for each of transmission streams of a baseband.

By combining the analog BF and the digital precoding process, for example, it becomes possible to optimize weighting of the analog BF and a precoding matrix or to optimize also the number of converters or baseband processing circuits.

However, for example, in terms of a certain beam formed by analog BF, the number of terminals that perform wireless communication with a base station apparatus utilizing the beam is sometimes smaller than a given number. In such a case, in comparison with an alternative case in which the number of terminals is greater than the given number, the utilization ratio of wireless resources sometimes decreases, resulting in decrease of the throughput.

Thus, there is an analog beam forming technology that utilizes a mini-slot. The mini-slot is a technology that performs scheduling, for example, in a unit of a symbol. For example, in the case where the number of terminals smaller than such a given number as described above are scheduled, since, in long term evolution (LTE), scheduling is performed in a unit of a sub-frame, such a state as described above continues at least for a sub-frame time period (14 symbols). However, in the case of an analog beam forming technology that utilizes the mini-slot, since scheduling is performed in a unit of a symbol, even in the case where the number of terminals smaller than the given number are scheduled, such a state as described above continues only for a period of time of one to several symbols. By performing scheduling in a unit of a symbol in this manner, for example, it is possible to improve the utilization ratio of wireless resources and suppress decrease of the throughput.

Examples of the related art include “Joint Fixed Beamforming and Eigenmode Precoding for Super High Bit Rate Massive MIMO Systems Using Higher Frequency Bands,” T. Obara, S. Suyama, J. Shen, and Y. Okumura, NTT DOCOMO, INC., Proc. 2014 IEEE 25th Annual International Symposium on Personal, Indoor, and Mobile Radio Communication, September 2014, and R1-1700629, “Mini-slot for analog beam-forming,” NTT DOCOMO, INC., 16th-20th Jan. 2017.

### SUMMARY

According to an aspect of the embodiments, a base station apparatus includes a processor and a plurality of antennas that transmit, to each of terminals, first and second wireless signals to form first and second beams, respectively, and receives, from each terminal, a third wireless signal including feedback information of the terminal in response to the second wireless signal. The processor selects, from among the terminals, based on the feedback information and a correlation value between the first beam and the second beam, a terminal to which the second beam is optimum, as a first terminal that performs communication via the first beam, or selects a terminal as a second terminal that performs communication via the second beam while communication via the first beam is performed in parallel. The plurality of antennas transmit a fourth wireless signal including data to each terminal apparatus to form the first beam or the second beam.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view depicting an example of a configuration of a wireless communication system;

FIG. 2 is a view depicting an example of a configuration of a base station apparatus;

FIG. 3 is a view depicting an example of a configuration of a terminal apparatus;

FIGS. 4A and 4B are views depicting an example of a configuration of a base station apparatus and a terminal apparatus, respectively;

FIG. 5 is a flow chart depicting an example of operation of a base station apparatus;

FIG. 6 is a flow chart depicting an example of operation of a base station apparatus;

FIG. 7 is a view depicting an example of a relationship between an analog beam and a terminal;

FIGS. 8A and 8B are views depicting an example of coefficients W_{NUE,m} and W_{CQIu}, respectively;

FIG. 9A is a view depicting an example of a relationship between analog beams #m and #n and a threshold value ┌_{A,u}, and FIG. 9B is a view depicting an example of a result of scheduling;

FIGS. 10A to 10C are views depicting examples of a digital beam;

FIGS. 11A and 11B illustrate a flow chart depicting an example of operation of a base station apparatus;

FIG. 12 is a flow chart depicting an example of operation of a base station apparatus;

FIGS. 13A to 13C are views depicting examples of a digital beam;

FIGS. 14A and 14B are views depicting an example of digital beams #m and #n;

FIG. 15A and 15B are views depicting an example of coefficients wₖ and w_{DSu}, respectively;

FIG. 16 is a view depicting an example of a relationship between digital beams #m and #n and a threshold value ┌_{D,u};

FIG. 17 is a view depicting an example of a coefficient wₐₙₜ; and

FIG. 18 is a view depicting an example of a configuration of a wireless communication system.

### DESCRIPTION OF EMBODIMENTS

In the case of the analog beam forming technology that utilizes the mini-slot, a base station apparatus performs allocation to terminal apparatus (users) in a unit of a symbol. Therefore, the base station apparatus inserts a demodulation reference signal (DMRS) in a unit of a symbol. Accordingly, in comparison with an alternative case in which a DMRS signal is inserted in a unit of a slot, according to the analog beam-forming technology that utilizes the mini-slot, a region to which wireless resources for data are to be allocated sometimes decreases, resulting in deterioration of the throughput because a DMRS is inserted in a unit of a symbol.

Therefore, it is desirable to provide a base station apparatus, a scheduling method and a wireless communication system that improve the throughput.

In the following, embodiments are described in detail with reference to the drawings. The subject and the embodiments are exemplary and does not restrict the scope of the right of the present application. Further, the individual embodiments may be combined suitably to the extent that the processing range does not conflict. Further, as the terms used herein and the technical contents described herein, terms described in specifications or technical contents specified by IEEE, third generation partnership project (3GPP) or the like may be used suitably.

### First Embodiment

<Example of Configuration of Wireless Communication System>

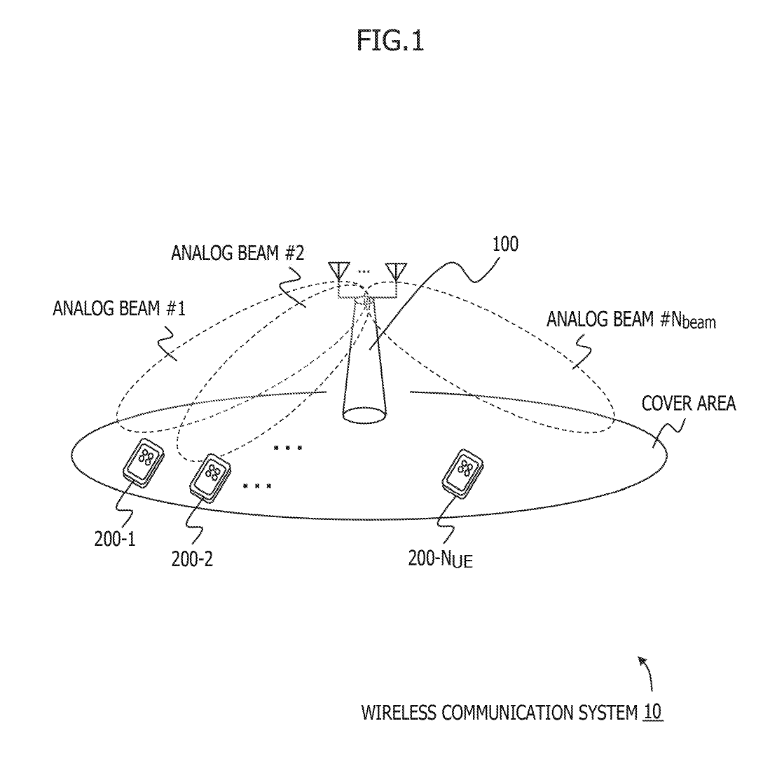

FIG. 1 is a view depicting an example of a configuration of a wireless communication system according to a first embodiment.

A wireless communication system 10 depicted in FIG. 1 includes a base station apparatus 100 (hereinafter referred to sometimes as “base station”), and a plurality of terminal apparatuses (each hereinafter referred to sometimes as “terminal”) 200-1 to 200-N_{UE}.

The base station 100 is a wireless communication apparatus that performs wireless communication, for example, with the plurality of terminals 200-1 to 200-N_{UE}. The base station 100 provides various services to the plurality of terminals 200-1 to 200-N_{UE} located in a cover area (or a range within which a service may be provided) by performing wireless communication with the terminals 200-1 to 200-N_{UE}. Along with this, the base station 100 transmits a wireless signal to the terminals 200-1 to 200-N_{UE} to form a plurality of analog beams #1 to #N_{beam} to transmit user data and so forth. As services to be provided, for example, there are a communication service, a Web browsing service and so forth.

The terminals 200-1 to 200-N_{UE} are wireless communication apparatuses capable of performing wireless communication, such as a smartphone, a feature phone, a tablet terminal, a personal computer, or a game apparatus. The terminals 200-1 and 200-2 may perform wireless communication with the base station 100 to enjoy various services provided through the base station 100.

It is to be noted that, while, in the example of FIG. 1, one base station 100 performs wireless communication with N_{UE} terminals 200-1 to 200-N_{UE}, a plurality of terminals will suffice. For example, N_{UE} may be N_{UE}=2. Also the analog beams #1 to #N_{beam} may be a plurality of analog beams, and for example, N_{beam} may be N_{beam}=2.

In the following, for example, each of the terminals 200-1 to 200-N_{UE} is sometimes referred to as terminal 200.

<Example of Configuration of Base Station Apparatus>

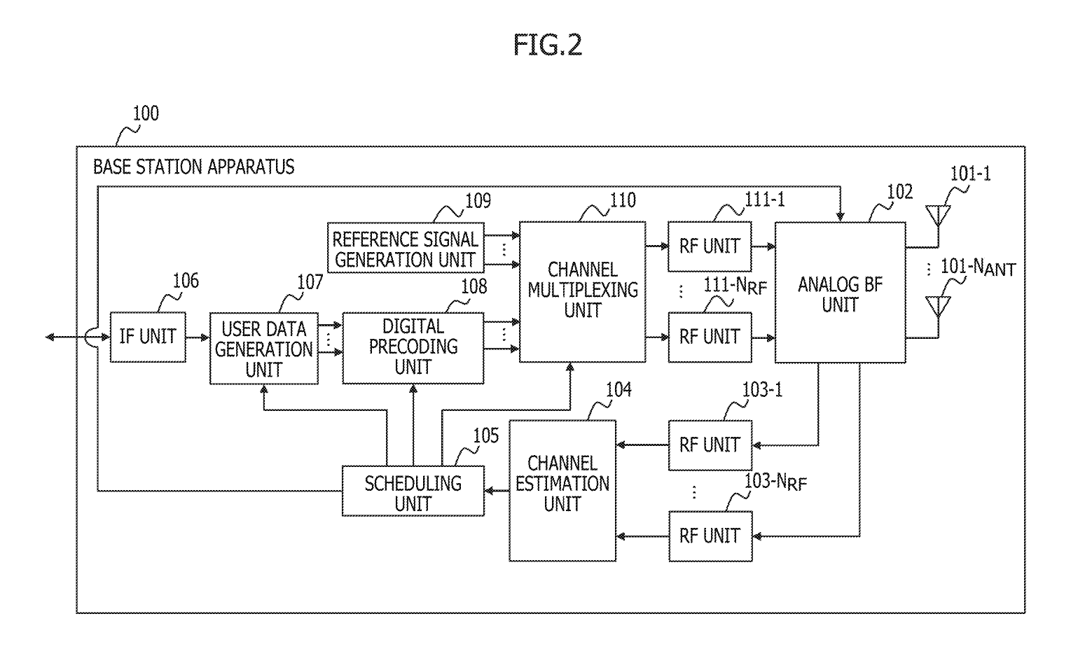

FIG. 2 is a view depicting an example of a configuration of a base station.

The base station 100 depicted in FIG. 1 includes antennas (or antenna elements; each of them is sometimes referred to as “antenna”) 101-1 to 101-N_{ANT} (ANT is an integer equal to or greater than 2), an analog BF unit 102, radio frequency (RF) units 103-1 to 103-N_{RF}, and a channel estimation unit 104. The base station 100 further includes a scheduling unit 105, an interface (IF) unit 106, a user data generation unit 107, a digital precoding unit 108, a reference signal generation unit 109, a channel multiplexing unit 110, and RF units 111-1 to 111-N_{RF}.

The antennas 101-1 to 101-N_{ANT} receive wireless signals outputted from the analog BF unit 102 and transmit the received wireless signals to the terminals 200. Further, the antennas 101-1 to 101-N_{ANT} receive wireless signals transmitted from the terminals 200 and output the received wireless signals to the analog BF unit 102.

The analog BF unit 102 performs weighting for a wireless signal outputted from each of the RF units 111-1 to 111-N_{RF}, based on a weighting value (or weighting factor) received from the scheduling unit 105. The analog BF unit 102 outputs the weighted wireless signals to the antennas 101-1 to 101-N_{ANT}. The weighting value may be represented, for example, by a complex function or the like with fixing a (main axis) direction of a beam. Accordingly, when the wireless signals weighted by the analog BF unit 102 are transmitted from the antennas 101-1 to 101-N_{ANT}, it becomes possible to form (transmission) analog beams #1 to #N_{beam} directed to a certain fixed direction.

Further, the analog BF unit 102 outputs wireless signals outputted from the antennas 101-1 to 101-N_{ANT} to the RF units 103-1 to 103-N_{RF}, respectively. The analog BF unit 102 performs weighting of the received wireless signals, based on weighting values received from the scheduling unit 105. Also in this case, the wireless signals received by the antennas 101-1 to 101-N_{ANT} may form (reception) analog beams #1 to #N_{beam} directed toward a certain fixed direction by the weighting.

In order to perform such weighting as described above, the analog BF unit 102 may include a phase controlling circuit, for example, for each antenna 101-1 to 101-N_{ANT}. The phase controlling circuit controls the phase of a wireless signal outputted from each of the RF units 111-1 to 111-N_{RF} or a wireless signal received from each of the antennas 101-1 to 101-N_{ANT} in accordance with weighting values outputted, for example, from the scheduling unit 105.

It is to be noted that each of the analog beams #1 to #N_{beam} is a flux of one or more wireless signals. By the analog BF unit 102, wireless signals having phases different from each other are transmitted from the plurality of antennas 101-1 to 101-N_{ANT}. The base station 100 may form one or more analog beams #1 to #N_{beam} having phases controlled to a certain direction by transmitting wireless signals having phases different from each other from the plurality of antennas 101-1 to 101-N_{ANT}.

In the following, to form analog beams #1 to #N_{beam} by transmission of wireless signals and to transmit wireless signals utilizing such analog beams #1 to #N_{beam} are sometimes used without distinguishing them from each other.

Further, the analog beams #1 to #N_{beam} are beams formed by wireless signals that are obtained, for example, by weighting wireless signals after frequency conversion.

Each of the RF units 103-1 to 103-N_{RF} performs a frequency conversion process and so forth for a wireless signal received from the analog BF unit 102 to convert (or down convert) the wireless signal into a baseband signal of a baseband. Each of the RF units 103-1 to 103-N_{RF} outputs the baseband signal after the conversion to the channel estimation unit 104.

The channel estimation unit 104 calculates a channel estimation value, for example, based on an uplink reference signal from among baseband signals and performs a reception process according to channel compensation, on the other baseband signals, by utilizing the calculated channel estimation value. The channel estimation unit 104 may extract, by the reception process or the like, a feedback signal transmitted from the terminal 200 from among the baseband signals. The channel estimation unit 104 outputs the extracted feedback signal to the scheduling unit 105.

It is to be noted that the channel estimation unit 104 may extract, by a reception process or the like, user data and so forth transmitted from the terminal 200, and in this case, the channel estimation unit 104 may output the extracted user data and so forth to the IF unit 106.

The scheduling unit 105 extracts feedback information and candidate beam information from the feedback signal. Then, the scheduling unit 105 determines, for example, based on a correlation value of a second beam to a first beam and a feedback signal of the terminal 200 to the first or second beam, whether or not a terminal 200 to which the second beam is optimum is to be selected as a terminal with which communication is to be performed using the first beam. For example, the scheduling unit 105 determines, based on the correlation value and the feedback information, whether or not a terminal to which the second beam is optimum is to be selected as a terminal with which communication is to be performed using the first beam. Details are hereinafter described in the description of an example of operation. The scheduling unit 105 outputs a signal indicative of a result of scheduling to the user data generation unit 107, digital precoding unit 108, channel multiplexing unit 110, and analog BF unit 102.

For example, the scheduling unit 105 outputs information relating to a terminal 200 (or a user) that has been allocated by scheduling, to the user data generation unit 107. Further, the scheduling unit 105 outputs, for example, a precoding matrix indicator (PMI) included in channel state information (CSI), from among feedback information, to the digital precoding unit 108. Further, the scheduling unit 105 outputs a result of scheduling to the channel multiplexing unit 110. Furthermore, the scheduling unit 105 outputs, for example, a weighting value relating to an analog beam to the analog BF unit 102.

The IF unit 106 receives, for example, packet data transmitted from the another station or a node apparatus, extracts user data and so forth destined for the terminal 200 from the received packet data, and outputs the extracted user data to the user data generation unit 107. Further, the IF unit 106 receives, for example, user data and so forth from the channel estimation unit 104, generates packet data for the received user data and so forth, and transmits the packet data to another base station or another node apparatus.

The user data generation unit 107 outputs, for example, in accordance with information relating to the user outputted from the scheduling unit 105, from among user data outputted from the IF unit 106, the user data corresponding to the user to the digital precoding unit 108. The user data generation unit 107 outputs one or more pieces of user data to the digital precoding unit 108.

The digital precoding unit 108 performs weighting on the user data, for example, in accordance with a PMI outputted from the scheduling unit 105. To perform a weighting process on user data (or a data stream) in a baseband in this manner is sometimes referred to, for example, as digital precoding (process). The digital precoding unit 108 outputs the weighted user data to the channel multiplexing unit 110.

The reference signal generation unit 109 generates a reference signal and outputs the generated reference signal to the channel multiplexing unit 110. As the reference signal, for example, there are a channel state information-reference signal (CSI-RS), a DMRS and so forth.

The channel multiplexing unit 110 multiplexes user data outputted from the digital precoding unit 108 and the reference signal outputted from the reference signal generation unit 109 into each channel, for example, in accordance with a scheduling result outputted from the scheduling unit 105. The channel multiplexing unit 110 outputs the multiplexed signals to the RF units 111-1 to 111-N_{RF}.

The RF units 111-1 to 111-N_{RF} convert (or up convert) the multiplexed signals of the baseband into wireless signals of a wireless band, for example, by a frequency conversion process or the like. The RF units 111-1 to 111-N_{RF} output the wireless signals after conversion to the analog BF unit 102.

<Example of Configuration of Terminal Apparatus>

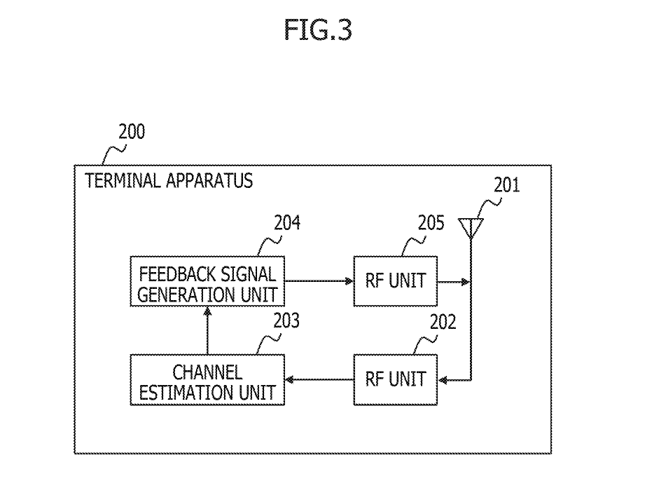

FIG. 3 is a view depicting an example of a configuration of a terminal.

The terminal 200 depicted in FIG. 3 includes an antenna 201, RF units 202 and 205, a channel estimation unit 203, and a feedback signal generation unit 204.

The antenna 201 receives a wireless signal transmitted from the base station 100, and outputs the received wireless signal to the RF unit 202. Further, the antenna 201 transmits a wireless signal outputted from the RF unit 205 to the base station 100.

The RF unit 202 performs, for example, a frequency conversion process and so forth on a wireless signal received from the antenna 201 to convert (or down convert) the wireless signal into a baseband signal of the baseband. The RF unit 202 outputs the baseband signal after the conversion to the channel estimation unit 203.

The channel estimation unit 203 calculates a channel estimation value, based on a reference signal from among baseband signals, and measures the communication quality between the base station 100 and the terminal 200 by using the calculated channel estimation value. The communication quality may be represented, for example, as channel quality indicator (CQI) or may be represented as a received power value with respect to the reference signal, a signal to noise ratio (SNR), or a signal to interference plus noise ratio (SINR). In the following description, the CQI is taken as an example of the communication quality.

Further, the channel estimation unit 203 calculates a PMI indicative of a desired precoding matrix or a rank indicator (RI) indicative of a desired stream number, for example, based on the measured communication quality. The channel estimation unit 203 outputs channel state information (CSI) including the RI, the CQI, and the PMI, as feedback signal, to the feedback signal generation unit 204.

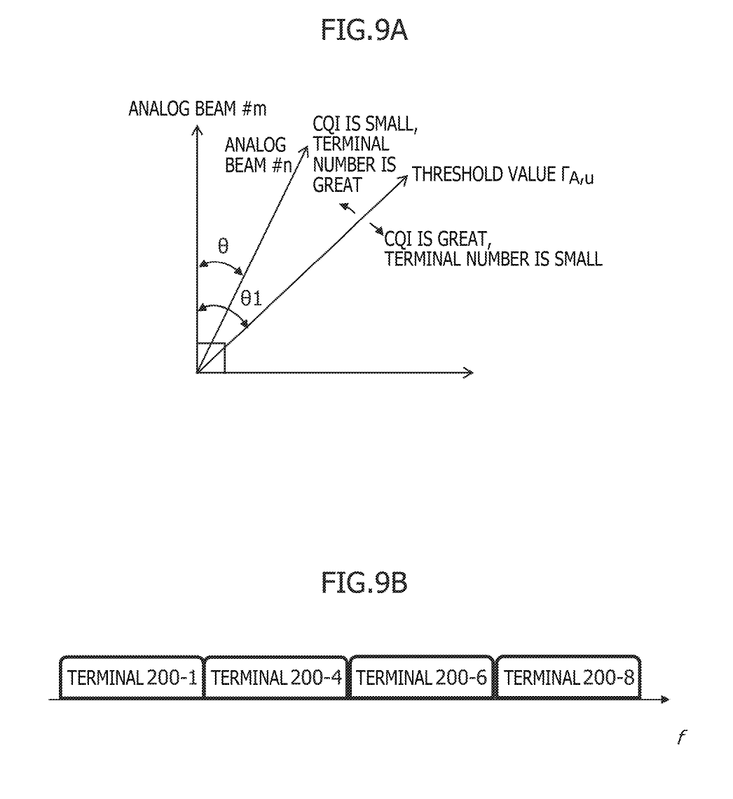

Furthermore, the channel estimation unit 203 calculates candidate beam information indicative of an optimum beam from among a plurality of beams formed by the base station 100. The channel estimation unit 203 may measure, for example, for each of the beams formed by the base station 100, the communication quality based on a reference signal transmitted using the beam, and select an optimum beam, based on the measured communication quality. As a range of the transmission frequency via which the reference signal is transmitted, for example, a range, within which the base station 100 may perform scheduling, may be applied. For example, while FIG. 9B depicts an example of a scheduling result, the reference signal may be included in a frequency range to which the terminals 200-1 to 200-8 are allocated. An optimum beam selected by the channel estimation unit 203 is sometimes referred to, for example, candidate beam. For example, in the example of FIG. 1, the candidate beam for the terminal 200-1 is the analog beam #1, and the candidate beam for the terminal 200-2 is the analog beam #2. Referring back to FIG. 2, the channel estimation unit 203 outputs the selected (or calculated) candidate beam information to the feedback signal generation unit 204.

The feedback signal generation unit 204 generates a feedback signal including feedback information and candidate beam information, and outputs the generated feedback signal to the RF unit 205.

The RF unit 205 performs, for example, a frequency conversion process and so forth on the feedback signal to convert (up convert) the feedback signal in the baseband to a wireless signal in the wireless band. The RF unit 205 outputs the wireless signal after the conversion to the antenna 201. It is to be noted that the RF unit 205 transmits, for example, a wireless signal corresponding to the feedback signal, by utilizing a physical uplink control channel (PUCCH) or a physical uplink shared channel (PUSCH) determined in advance.

<Example of Hardware Configuration of Base Station and Terminal>

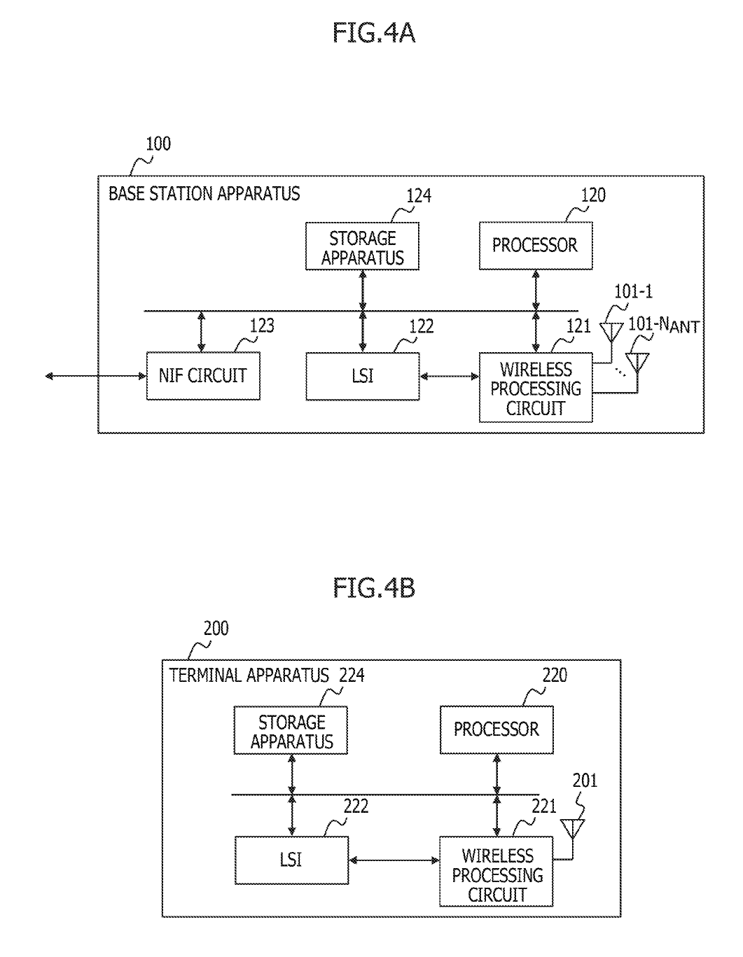

FIG. 4A is a view depicting an example of a hardware configuration of a base station.

The base station 100 depicted in FIG. 4A further includes a processor 120, a wireless processing circuit 121, a large-scale integration (LSI) 122, a network interface (NIF) circuit 123, and a storage apparatus 124.

The processor 120 may read out, for example, a program stored in the storage apparatus 124, and execute the read out program to implement functions of the scheduling unit 105, user data generation unit 107, and digital precoding unit 108. The processor 120 corresponds, for example, to the scheduling unit 105, user data generation unit 107, and digital precoding unit 108.

The LSI 122 may implement functions of the channel estimation unit 104, reference signal generation unit 109, and channel multiplexing unit 110, for example, in accordance with an instruction from the processor 120. The LSI 122 corresponds, for example, to the channel estimation unit 104, reference signal generation unit 109, and channel multiplexing unit 110.

Further, the wireless processing circuit 121 corresponds, for example, to the analog BF unit 102, RF units 103-1 to 103-N_{RF}, and RF units 111-1 to 111-N_{RF}. Furthermore, the NIF circuit 123 corresponds, for example, to the IF unit 106.

FIG. 4B is a view depicting an example of a hardware configuration of a terminal.

The terminal 200 depicted in FIG. 4B further includes a processor 220, a wireless processing circuit 221, an LSI 222, and a storage apparatus 224.

The processor 220 reads out, for example, a program stored in the storage apparatus 224 and executes the read out program to implement the function of the feedback signal generation unit 204. The processor 220 corresponds, for example, to the feedback signal generation unit 204.

Meanwhile, the LSI 222 implements the function of the channel estimation unit 203, for example, in accordance with an instruction from the processor 220. The LSI 222 corresponds, for example, to the channel estimation unit 203.

Further, the wireless processing circuit 221 corresponds, for example, to the RF units 202 and 205.

It is to be noted that each of the processors 120 and 220 may be a control unit or a controller, such as a central processing unit (CPU), a micro processing unit (MPU), a digital processing unit (DSP), or a field programmable gate array (FPGA).

Further, each of the storage apparatuses 124 and 224 may be a read only memory (ROM), a random access memory (RAM), a hard disk drive (HDD), or a combination thereof.

<Example of Operation>

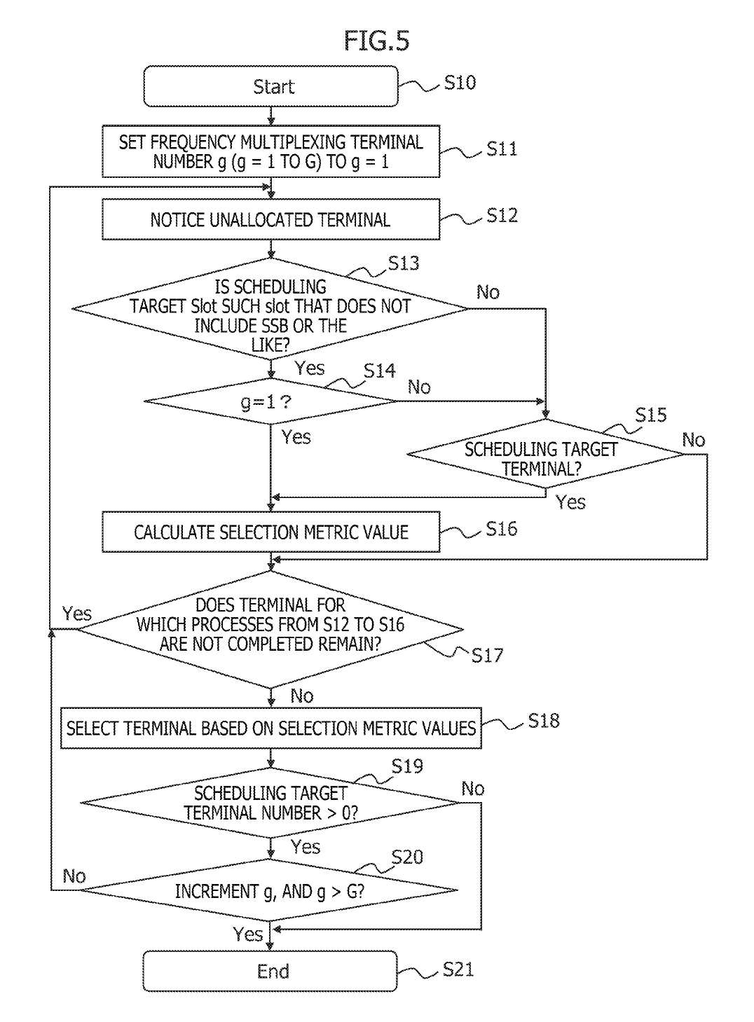

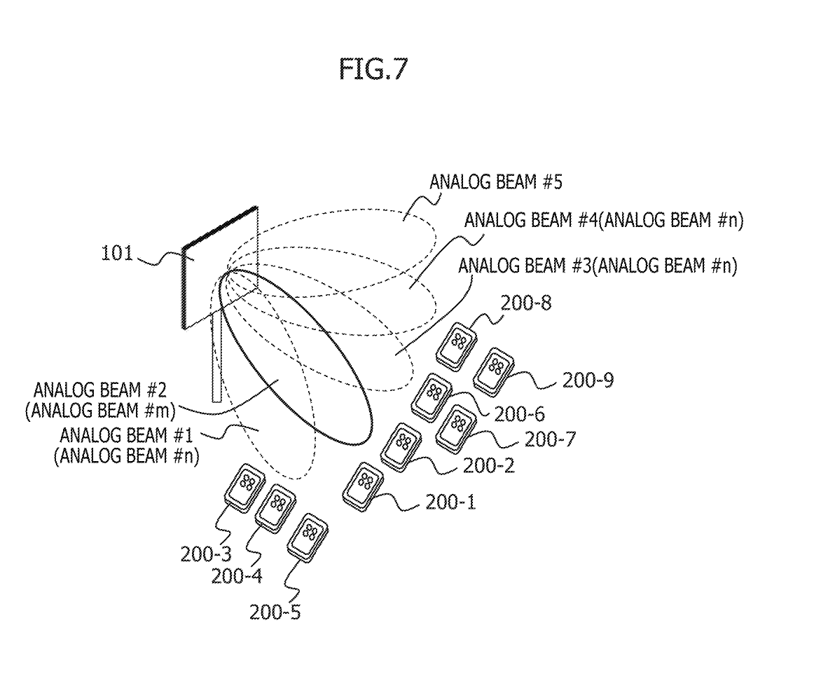

FIG. 5 is a flowchart depicting an example of operation of the base station 100. FIG. 7 is a view depicting an example of a relationship between analog beams #1 to #5 (N_{beam}=5) and the terminals 200-1 to 200-9 (N_{UE}=9). The example of operation of FIG. 5 is described with additional reference to FIG. 7.

It is assumed here that, before the operation depicted in FIG. 5, the base station 100 has acquired candidate beam information and feedback information from the terminals 200-1 to 200-9. In the example of FIG. 7, the candidate beam for the terminals 200-1 and 200-2 is the analog beam #2, and the candidate beam for the terminals 200-3 to 200-5 is the analog beam #1. Further, the candidate beam for the terminals 200-6 and 200-7 is the analog beam #3, and the candidate beam for the terminals 200-8 and 200-9 is the analog beam #4.

Further, it is assumed that the base station 100 receives data destined for the terminals 200-1 to 200-9 from a node apparatus.

Referring back to FIG. 5, after the base station 100 starts its processing (S10), it sets the number of terminals g (hereinafter referred to sometimes as “frequency multiplexing terminal number”) whose frequency is able to be multiplexed, to g=1 (S11). The frequency multiplexing terminal number g indicates, for example, the number of terminals that may be allocated to one analog beam by a single time of scheduling. Meanwhile, G indicates, for example, a maximum value of the frequency multiplexing terminal number g. In the following process, the scheduling unit 105 selects G terminals 200 in the maximum from among, for example, the N_{UE} terminals 200.

FIG. 9B is a view depicting a final result of scheduling for the analog beam #2 in the present example of operation. In FIG. 9B, an example is depicted in which the maximum value G of the frequency multiplexing terminal number g is G=4. The base station 100 starts the process by setting the frequency multiplexing terminal number g at “1”, and successively increments the frequency multiplexing terminal number g to perform scheduling for the terminals 200-1 to 200-9. In the present process (S10), for example, the scheduling unit 105 sets the frequency multiplexing terminal number g to g=1.

It is to be noted that the base station 100 may calculate the maximum value G in the process of S11. For example, the scheduling unit 105 may calculate the maximum value G, for each of the analog beams #1 to #4, based on the wireless resource amount that may be allocated by a single time of scheduling, and the amount of data destined for each of the terminals 200-1 to 200-9.

Referring back to FIG. 5, the base station 100 subsequently notices an unallocated terminal 200 (S12). For example, in the example of FIG. 7, the scheduling unit 105 notices the terminal 200-1. In the following description, the terminal on which attention has been focused at S12 is sometimes referred to as noticed terminal 200. The noticed terminal 200 is, for example, a terminal other than the terminals selected by a process at S18 hereinafter described.

Referring back to FIG. 5, the base station 100 subsequently decides whether or not the scheduling target slot is a slot that does not include a synchronization signal block (SSB) and a CSI-RS or the like but includes a DMRS and data (S13).

As types of slot, for example, there is a slot that includes an SSB and a CSI-RS, and a slot that does not include any of an SSB and a CSI-RS but includes a DMRS and data. The former type is sometimes referred to as pattern (1) and the latter type is sometimes referred to as pattern (2). Further, the former is sometimes referred to as “slot including an SSB” and the latter is sometimes referred to as “slot that does not include an SSB.”

For example, when the scheduling target slot is the pattern (1), the scheduling unit 105 makes a decision of “No” at S13, but when the scheduling target slot is the pattern (2), the scheduling unit 105 makes a decision of “Yes” at S13.

The base station 100 decides, when the scheduling target slot is the pattern (2) (Yes at S13), whether or not the frequency multiplexing terminal number g is g=1 (S14).

When the frequency multiplexing terminal number g is g=1 (Yes at S14), the base station 100 calculates a selection metric value (S16).

The selection metric represents, for example, a norm for selecting a terminal to be made a scheduling target from among a plurality of terminals 200. As an example of the selection metric, for example, there is a proportional fair (PF) norm (hereinafter referred to sometimes as “PF norm”). For example, the scheduling unit 105 may calculate a selection metric value, based on feedback information (for example, a CQI) fed back from each of the terminals 200-1 to 200-9. For example, the scheduling unit 105 may calculate instant received power from the received CQI and calculate the ratio between the instant received power and average received power as the selection metric value.

As the selection metric, there is also a round robin norm. The round robin norm is a norm that allocates wireless resources to the terminals 200 in order, for example, beginning with “1.” In this case, the scheduling unit 105 successively selects the terminals 200-1 to 200-9 in the process of S16.

For example, the scheduling unit 105 calculates a selection metric value for the noticed terminal 200-1 by using the PF norm or the like.

Then, the base station 100 decides whether or not there remains a terminal for which the processes at S12 to S16 are not completed (S17). The processes at S12 to S16 are hereinafter referred to sometimes as “first process.” The base station 100 decides, in the case where the processes at S12 to S16 are completed for all terminals 200-1 to 200-9 that become a scheduling target when g=1, that the first process is completed (No at S17), but in any other case, the base station 100 decides that the first process is not completed (Yes at S17).

In the example of FIG. 7, for example, the scheduling unit 105 makes a decision of Yes at S17 because the selection metric value is calculated for the terminal 200-1 and the first process is not performed for the other terminals 200-2 to 200-9. In this case, the base station 100 selects a terminal 200 from among the terminals 200-2 to 200-9 as a noticed terminal (S12). Here, the base station 100 selects, for example, the terminal 200-2 as a noticed terminal. Thereafter, the base station 100 performs, for example, the following processes.

For example, the base station 100 does not change the scheduling target slot from that in the case where the terminal 200-1 is made a noticed terminal in the pattern (2) (Yes at S13) and there is no change also in g=1 (Yes at S14), and the base station 100 calculates the selection metric value of the terminal 200-2 (S16). The base station 100 checks again whether or not the first process is completed, and since the terminals 200-3 to 200-9 remain as terminals for which the first process is not completed (Yes at S17), the base station 100 notices, for example, the terminal 200-3 and calculates the selection metric value (Yes at S13, Yes at S14, and S16). Thereafter, the base station 100 calculates the selection metric value for the terminals 200-4 to 200-9 (Yes at S13, Yes at S14, and S16).

When the base station 100 decides that there remains no terminal for which the first process is not completed (No at S17), the base station 100 selects a terminal 200 based on the selection metric value (S18). For example, when the scheduling unit 105 completes the first process for all terminals 200-1 to 200-9 with g=1, the scheduling unit 105 decides that there remains no terminal for which the first process is not completed, and selects a terminal 200, based on the selection metric value. In the example of FIG. 7, the scheduling unit 105 selects the terminal 200-1.

By this selection, the scheduling unit 105 allocates a wireless resource for the analog beam #1 to the terminal 200-1. Accordingly, as depicted in FIG. 9B, to the terminal 200-1 as the terminal 200 of g=1, a wireless resource for the analog beam #2 is allocated.

Referring back to FIG. 5, the base station 100 subsequently decides whether or not there exists a terminal 200 of a scheduling target (S19). For example, the scheduling unit 105 may make the decision depending upon whether or not there exists some remaining amount of wireless resources available for terminals, whose number is represented as a scheduling target terminal number, when a wireless resource is allocated to the terminal 200 selected at S18.

When a terminal 200 of a scheduling target exists, or the scheduling target terminal number is greater than 0 (Yes at S19), the base station 100 increments the frequency multiplexing terminal number g and decides whether or not the incremented frequency multiplexing terminal number g exceeds the maximum value G (S20). For example, the scheduling unit 105 compares the incremented frequency multiplexing terminal number g and the maximum value G calculated at S11 to decide whether or not the former exceeds the latter. In the example of FIG. 7, the scheduling unit 105 increments g to g=2, and since g does not exceed the maximum value G=4, the scheduling unit 105 makes a decision of “No” at S20 and advances the processing to S12.

The following description is given with reference to FIG. 5 in the example in which g=2.

At S12, for example, the scheduling unit 105 notices the terminal 200-2 as an unallocated terminal (S12), and decides whether or not the scheduling target slot is the pattern (2) (S13). In the case after g=2, irrespective of whether the scheduling target slot is the pattern (1) (No at S13) or the pattern (2) (No at S14), the processing advances to S15, at which the scheduling unit 105 performs a decision of whether or not the noticed terminal 200-2 is a scheduling target terminal.

In the example, it is assumed that, when the scheduling target slot is the pattern (1) (No at S13), the analog beam formed using the slot is referred to as analog beam #a. On the other hand, it is assumed that, when the scheduling target slot is the pattern (2) (Yes at S13), the analog beam selected with g=1 is referred to as analog beam #b. The base station 100 uses the analog beam #a or #b to perform a decision process (S15).

It is to be noted that the decision process (S15) is described taking, as an example, the analog beam #b selected with g=1 when the scheduling target slot is the pattern (2) (Yes at S13). The decision process in the case of the analog beam #a is described after an example of the analog beam #b is described.

In the example of FIG. 7, as an example in which g=1, the base station 100 has selected the terminal 200-1 as a terminal 200 of a scheduling target (S18). In the example of FIG. 7, the candidate beam of the terminal 200-1 is the analog beam #2. Accordingly, the base station 100 performs a decision process by using the analog beam #2 as the analog beam #b. In the decision process, for example, the base station 100 decides whether or not each of the unallocated terminals 200-2 to 200-9 may be selected as a target for communication using the analog beam #b (here, the analog beam #2).

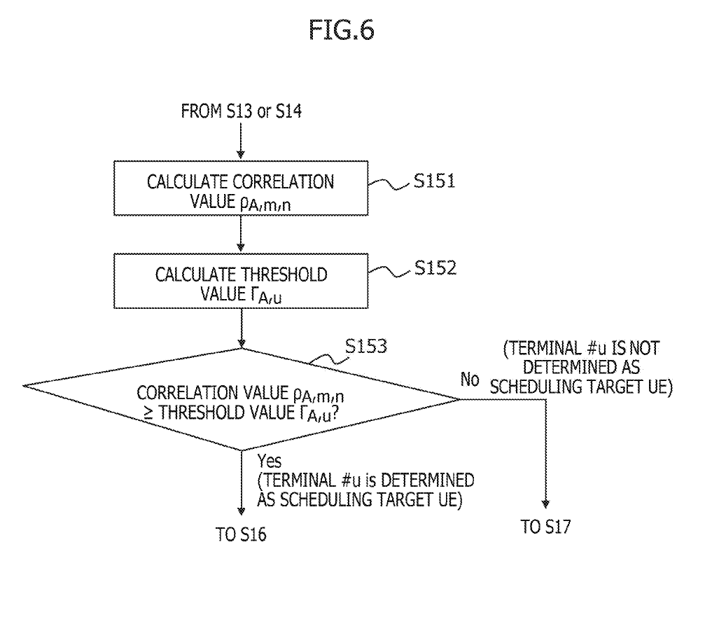

FIG. 6 is a flowchart depicting an example of a decision process (S15).

The base station 100 calculates a correlation value ρ_{A,m,n} in the decision process (S151). Here, the base station 100 determines an analog beam #m and another analog beam #n, and calculates a correlation value ρ_{A,m,n} between the two analog beams #m and #n.

The analog beam #m is, for example, an analog beam to be used for a scheduling target slot, and the analog beam #a or #b corresponds to the analog beam #m. For example, in the example of FIG. 7, since the candidate beam for the terminal 200-1 selected with g=1 is the analog beam #2, the analog beam #2 becomes the analog beam #m.

On the other hand, the analog beam #n is an analog beam corresponding to the candidate beam, for example, for an unallocated terminal 200 (or noticed terminal 200). For example, in the example of FIG. 7, the analog beams #1, #2, #3 and #4 that are candidate beams for the noticed terminals 200-2 to 200-9 may become the analog beam #n.

In the example of FIG. 7, since, in the case of the noticed terminal 200-2, the analog beam #m=analog beam #2 and the candidate beam for the noticed terminal 200-2 is the analog beam #2, in the case of the noticed terminal 200-2, the analog beam #n=analog beam #2.

Then, the base station 100 calculates the correlation value ρ_{A,m,n} of the analog beam #n to the analog beam #m, for example, using the following expression:

$$\begin{matrix}[ Expression 1 ] & \\ {ρ}_{A , m , n} = {\vert \frac{{w}_{m} \cdot {w}_{n}^{H}}{‖ {w}_{m} ‖ ‖ {w}_{n} ‖} \vert}^{2} & ( 1 )\end{matrix}$$

In the expression (1), wₘ is a weight vector that is outputted from the scheduling unit 105 to the analog BF unit 102 when the analog beam #m is formed by the antennas 101-1 to 101-N_{ANT}, and is to be applied to a wireless signal. Further, wₙ is a weight vector that is outputted from the scheduling unit 105 to the analog BF unit 102 when the analog beam #n is to be formed by the antenna 101-1 to 101-N_{ANT}, and is to be applied to a wireless signal.

The second term of the numerator on the right side of the expression (1) represents an Hermitian transposed matrix of the weight vector wₙ, and may be represented as the weight vector wₙ itself. Accordingly, by performing calculation of the inner product, the right side of the expression (1) becomes |cosθ|². Here, θ represents an angle, for example, defined by the two weight vectors wₘ and wₙ. It is to be noted that the two weight vectors wₘ and wₙ may be represented using a complex vector.

Accordingly, the correlation value ρ_{A,m,n} may be regarded as representing, for example, an index indicating a degree of the angle between the analog beam #m and the analog beam #n that is a candidate beam for the noticed terminal 200, in other words, an index indicating to what degree the analog beams #m and #n are close to or apart from each other.

When the scheduling target slot is the pattern (2) (Yes at S13 of FIG. 5), the scheduling unit 105 sets the analog beam selected with g=1 as the analog beam #b=analog beam #m (or m=b). In the example of FIG. 7, the analog beam #m is the analog beam #2. Therefore, the scheduling unit 105 calculates the correlation value ρ_{A,m,n} between the analog beam #2 and the analog beam #2 (=analog beam #n) that is the candidate beam for the noticed terminal 200-2.

On the other hand, when the scheduling target slot is the pattern (1) (No at S13 of FIG. 5), the scheduling unit 105 sets the analog beam formed in the pattern (1) as the analog beam #a and determines m as m=a, and then calculates the correlation value ρ_{A,m,n}. Details in this case are hereinafter described.

The scheduling unit 105 retains the expression (1), for example, in an internal memory or the like, reads out the weight vector wₘ corresponding to the analog beam #m and the weight vector wₙ corresponding to the analog beam #n from the internal memory, and substitutes the weight vector wₘ and the weight vector wₙ into the expression (1) to obtain a correlation value 92 _{A,m, n}. Alternatively, the scheduling unit 105 may retain, for example, correlation values ρ_{A,m,n} corresponding to combinations of arbitrary weight vectors wₘ and wₙ in the internal memory in advance so that, in the present process, it reads out a correlation value ρ_{A,m,n} corresponding to a combination (m, n) of arbitrary weight vectors from the internal memory.

Referring back to FIG. 6, the base station 100 subsequently calculates a threshold value ┌_{A,u} (S152). For example, the base station 100 calculates the threshold value ┌_{A,u} by using the following expression (2):

[Expression 2]

Γ_{A,u}=pw_{N}_{_{UE,m}}+qw_{CQI}_{ᵤ} (2)

In the expression (2), w_{NUE,m} represents a coefficient determined, for example, by the number of terminals N_{UE,m} corresponding to the analog beam #m. The number of terminals N_{UE,m} corresponding to the analog beam #m represents, for example, the number of terminals 200 that utilizes the analog beam #m.

For example, in the example of FIG. 7, since the terminal 200-1 is scheduled for the analog beam #2 (=analog beam #m) and the terminal 200-2 is a noticed terminal, the number of terminals N_{UE,m} corresponding to the analog beam #m is N_{UE,m}=2.

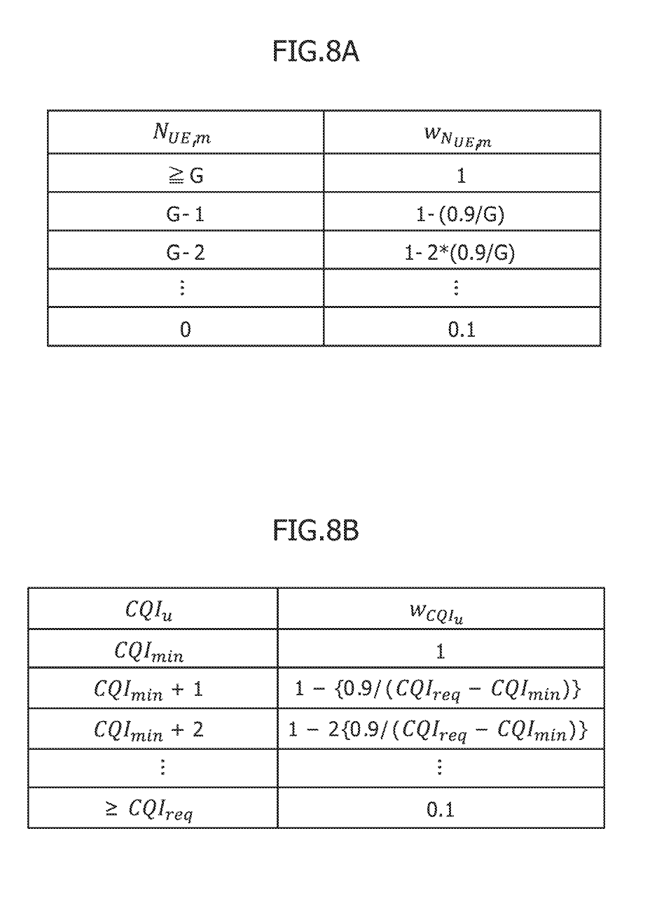

FIG. 8A depicts an example of the coefficient W_{NUE,m}. The coefficient w_{NUE,m} is set such that, for example, it has a numerical value that decreases as the number of terminals N_{UE,m} decreases (or comes closer to “0”) and has a numerical value that increases as the number of terminals N_{UE,m} increases (or comes closer to the maximum value G). Alternatively, the scheduling unit 105 sets the coefficient w_{NUE,m} (or the threshold value ┌_{A,u}) such that, for example, it has a value that comes closer to “0” (or “0.1”) as the number of terminals N_{UE,m} comes closer to “0” and has a value that comes closer to “1” as the number of terminals N_{UE,m} comes closer to the maximum value G.

Further, in the expression (2), w_{CQIu} represents a coefficient determined by an index CQIᵤ representative of the reception quality, for example, in the noticed terminal 200-u. In the example of FIG. 7, CQIᵤ of the noticed terminal 200-2 is a CQI for the analog beam #2 (=candidate beam=analog beam #m). Further, in the case where the terminal 200-3 becomes a noticed terminal, CQIᵤ of the same may be the CQI of the analog beam #1 (candidate beam) or the CQI of the analog beam #2 (analog beam #m).

FIG. 8B represents an example of the coefficient w_{CQIu}. The coefficient w_{CQIu} is set such that, for example, it has a value that increases as CQIᵤ decreases and decreases as CQIᵤ increases. Alternatively, the scheduling unit 105 may set the coefficient w_{CQIu} (or the threshold value ┌_{A,u}) such that the value comes closer to “1” as the CQI comes closer to “0” and comes closer to “0” (or “0.1”) as the CQI comes closer to the requested CQI (CQI_{req}) requested by the terminal 200.

The coefficients w_{NUE,m} and w_{CQIu} indicated in FIGS. 8A and 8B are an example and may have some other numerical values if they have such a relationship in magnitude as described hereinabove.

Further, in the expression (2), p and q are weighting coefficients for the coefficients w_{NUE,m} and w_{CQIu}, and may be set at arbitrary values by the user. For example, the base station 100 may set one of p and q at “0” to use one of the coefficients w_{NUE,m} and w_{CQIu} as the threshold value ┌_{A,u}.

For example, the scheduling unit 105 reads out the expression (2) stored in the internal memory, and substitutes the CQI extracted from feedback information and the number of terminals N_{UE,m} allocated to the analog beam #m into the expression (2) to calculate the threshold value ┌_{A,u}.

In this manner, the base station 100 may control (or change) the threshold value ┌_{A,u} for each terminal 200.

Referring back to FIG. 6, the base station 100 subsequently decides whether or not the correlation value ρ_{A,m,n} is equal to or greater than the threshold value ┌_{A,u} (S153). Then, when the correlation value ρ_{A,m,n} is equal to or greater than the threshold value ┌_{A,u} (Yes at S153), the base station 100 determines the noticed terminal 200-u as a scheduling target. On the other hand, when the correlation value ρ_{A,m,n} is smaller than the threshold value ┌_{A,u} (No at S153), the base station 100 does not determine the noticed terminal 200-u as a scheduling target.

For example, in the example of FIG. 7, when the correlation value ρ_{A,m,n} between the analog beam #2 (m=2) and the analog beam #2 (n=2) is equal to or greater than the threshold value ┌_{A,u} (Yes at S153), the scheduling unit 105 determines the noticed terminal 200-2 as a terminal of a scheduling target. On the other hand, when the correlation value ρ_{A,2,1} is smaller than the threshold value ┌_{A,3} (No at S153), scheduling unit 105 does not determine the noticed terminal 200-2 as a terminal of a scheduling target of the analog beam #1

FIG. 9A is a view depicting an example of a relationship between the correlation value ρ_{A,m,n} and the threshold value ┌_{A,u}.

The threshold value ┌_{A,u} includes coefficients w_{NUE,m} and w_{CQIu} as indicated by the expression (2). Accordingly, the threshold value ┌_{A,u} transits such that the angle θ1 defined by the threshold value ┌_{A,u} and the analog beam #m increases as the number of terminals N_{UE,m} corresponding to the analog beam #m decreases and as CQIu for the analog beam #m increases.

On the other hand, the threshold value ┌_{A,u} transits such that the angle θ1 defined between the threshold value ┌_{A,u} and the analog beam #m decreases as the number of terminals N_{UE,m} corresponding to the analog beam #m increases and as the index CQIᵤ for the analog beam #m decreases.

For example, the threshold value ┌_{A,u} is adjusted such that, for example, the number of terminals N_{UE,m} corresponding to the analog beam #m is appropriate, and such that a terminal, whose communication quality is equal to or higher than a fixed level even if the analog beam #m is utilized, is scheduled.

Then, when the correlation value ┌_{A,m,n} becomes equal to or greater than the threshold value ┌_{A,u} adjusted in this manner (Yes at S153), the base station 100 selects the aimed noticed terminal 200-u as a terminal of a scheduling target of the analog beam #m.

For example, as depicted in FIG. 9A, the analog beam #n sometimes exists such that the angle θ defined by the analog beam #m and the analog beam #n remains within a range of the angle θ1 defined by the threshold value ┌_{A,u} with reference to the analog beam #m. In such a case as just described, the base station 100 selects the noticed terminal 200-u, for which such an analog beam #n as described above is the candidate beam, as a terminal 200 of a scheduling target.

In this case, the analog beam #n exists within a range narrower than the threshold value ┌_{A,u} or more with respect to the analog beam #m. Therefore, even if the terminal 200 for which the analog beam #n is the candidate beam receives data transmitted thereto by utilizing the analog beam #m, the analog beam #n becomes an analog beam that is guaranteed sufficiently in terms of the number of terminals or the communication quality.

On the other hand, when the correlation value ρ_{A,m,n} is smaller than the threshold value ┌_{A,u} adjusted in such a manner as described above (No at S153), the base station 100 does not select the noticed terminal 200-u as a terminal of a scheduling target of the analog beam #m.

For example, the angle θ defined by the analog beam #m and the analog beam #n sometimes exists which exceeds a range of the angle θ1 defined by the threshold value ┌_{A,u} with respect to the analog beam #m as depicted in FIG. 9A.

In this case, the analog beam #n exists at an angle spaced from the threshold value ┌_{A,u} with respect to the analog beam #m. Therefore, even if data is transmitted toward the terminal 200, for which the analog beam #n is the candidate beam, by utilizing the analog beam #m, the analog beam #m is not guaranteed in terms of the number of terminals or the communication quality. In this case, the base station 100 does not determine the noticed terminal 200-u, for which the analog beam #n is the candidate beam, as a scheduling target for the analog beam #m.

For example, the scheduling unit 105 decides whether or not the noticed terminal 200-u is to be made a scheduling target depending upon whether or not the correlation value ρ_{A,m,n} calculated at S151 is equal to or greater than the threshold value ┌_{A,u} calculated at S152 (S153).

Referring back to FIG. 5, when the noticed terminal 200 is made a scheduling target (Yes at S15), the base station 100 calculates the selection metric of the noticed terminal 200 (S16). For example, the scheduling unit 105 calculates the selection metric of the noticed terminal 200 that is made a scheduling target.

On the other hand, when the noticed terminal 200 is not made a scheduling target (No at S15), the base station 100 advances its processing to S17 without calculating the selection metric of the noticed terminal 200.

In the example of FIG. 7, the scheduling unit 105 decides that the noticed terminal 200-2 is a terminal of a scheduling target (Yes at S15) and calculates the selection metric of the noticed terminal 200-2 (S16).

Since, in the case where g=2, the scheduling unit 105 has not performed the first process for the terminals 200-3 to 200-9 (Yes at S17), it preforms the processes at S13 to S16, for example, by setting the terminal 200-3 as a noticed terminal. The base station 100 performs, for example, the following processes.

For example, the scheduling unit 105 sets, for example, the terminal 200-3 as a noticed terminal and decides whether or not the noticed terminal is a scheduling target terminal (S15). In this case, the scheduling unit 105 calculates, using m=2, n=1 and u=3, the correlation value ρ_{A,2,1} and the threshold value ┌_{A,3} and compares them with each other to make a decision (S153). In this case, the scheduling unit 105 decides, for example, that the correlation value ρ_{A,2,1} is greater (Yes at S153 of FIG. 6). Then, the scheduling unit 105 calculates the selection metric of the terminal 200-3. The scheduling unit 105 repeats such processes as described above to perform the decision process for the noticed terminal 200 (S15). Then, after the scheduling unit 105 performs the processes at steps S13 to S16 for the terminals 200-2 to 200-9, it makes a decision of No at S17 and selects a terminal 200 from the calculated selection metric values (S18). In this case, the scheduling unit 105 here selects the terminal 200-4 as a terminal for which scheduling is to be performed (S18). As depicted in FIG. 19B, in the case of g=2, a wireless resource is allocated to the terminal 200-4.

Thereafter, the base station 100 repeats S12 to S20 until G=4 is reached. Then, when the frequency multiplexing terminal number g exceeds the maximum value G (Yes at S20), the base station 100 ends the scheduling (S21). Even in the case where the frequency multiplexing terminal number g does not exceed the maximum value G, in the case where a wireless resource amount that may be allocated once is exceeded (No at S19), the base station 100 ends the scheduling (S21).

FIG. 9B is a view depicting an example of allocation by scheduling. To the analog beam #m, the four terminals 200-1, 200-4, 200-6 and 200-8 are allocated. In this case, for example, the base station 100 performs the following processes.

For example, the scheduling unit 105 instructs the user data generation unit 107 to output user data destined for the terminals 200-1, 200-4, 200-6 and 200-8. Further, the scheduling unit 105 outputs weighting values indicative of a result of allocation to the analog BF unit 102. The analog BF unit 102 performs weighting for wireless signals including data destined for the terminals 200-1, 200-4, 200-6 and 200-8 in accordance with the weighting values, and outputs the resulting wireless signals to the antennas 101-1 to 101-N_{ANT}. From the antennas 101-1 to 101-N_{ANT}, the weighted wireless signals are transmitted to form an analog beam #2, and wireless signals including the data are transmitted to the terminals 200-1, 200-4, 200-6 and 200-8.

Here, operation when the scheduling target slot is the pattern (1) (No at S13) after the base station 100 sets g to g=1 (S12) is described.

In the example of FIG. 7, an analog beam formed from a slot including an SSB may become one of the analog beams #1 to #5. Such an analog beam as just described is determined in advance by the scheduling unit 105. Here, it is assumed that the analog beam #1 is an analog beam formed from a slot including an SSB. In this case, the scheduling unit 105 performs the decision process (S15) by setting the analog beam #1 as the analog beam #a and setting this analog beam #a as the analog beam #m. For example, in the case where the terminal 200-1 is made a noticed terminal (S12), the scheduling unit 105 calculates the correlation value ρ_{A,m,n} from the analog beam #1 (=analog beam #a=analog beam #m) and the analog beam #2 (=analog beam #n) that is a candidate beam for the terminal 200-1 (S151) and further calculates the threshold value ┌_{A,u} (S152), and then decides from a relationship in magnitude between the correlation value ρ_{A,m,n} and the threshold value ┌_{A,u} whether or not the terminal 200-1 is a scheduling target (S153). On the other hand, when the terminal 200-3 is made a noticed terminal (S12), the scheduling unit 105 performs calculation of the correlation value ρ_{A,m,n} and so forth from the analog beam #1 (=analog beam #a=analog beam #m) and the analog beam #2 (=analog beam #n) that is a candidate beam for the terminal 200-3 (S151 and S152). Then, the scheduling unit 105 decides whether or not the terminal 200-3 is a scheduling target (S153). Thereafter, the scheduling unit 105 performs the decision process also for the unallocated terminals 200-4 to 200-9 and selects a terminal 200 based on the selection metric values.

The scheduling unit 105 performs the decision process (S15) and so forth by setting the analog beam #m, which is to be made a target of the decision process, to the analog beam #a or the analog beam #b depending upon whether the scheduling target slot is the pattern (1) or the pattern (2).

As described above, in the first embodiment, the base station 100 may allocate the terminal 200-1, and besides, the terminals 200-4, 200-6 and 200-8 to the analog beam #2.

Therefore, for example, in comparison with an alternative case in which the base station 100 allocates only the terminals 200-1 and 200-2 to the analog beam #2, it is possible to allocate terminals 200 to a full frequency band that is utilized for transmission of the analog beam #2 as depicted in FIG. 9B.

Accordingly, in the first embodiment, since a wireless resource for an analog beam is utilized effectively, improvement in throughput may be achieved.

Further, in the first embodiment, allocation of wireless resources is performed in a unit of a slot. On the other hand, in the mini-slot technology, allocation of wireless resources is performed in a unit of a symbol and a DMRS is transmitted in a unit of a symbol. Accordingly, in the first embodiment, since transmission opportunities of a DMRS are reduced in terms of a unit of a slot in comparison with that in the case of a mini-slot, improvement of the throughput may be achieved.

### Second Embodiment

A second embodiment is an example in which spatial multiplexing is applied to scheduling.

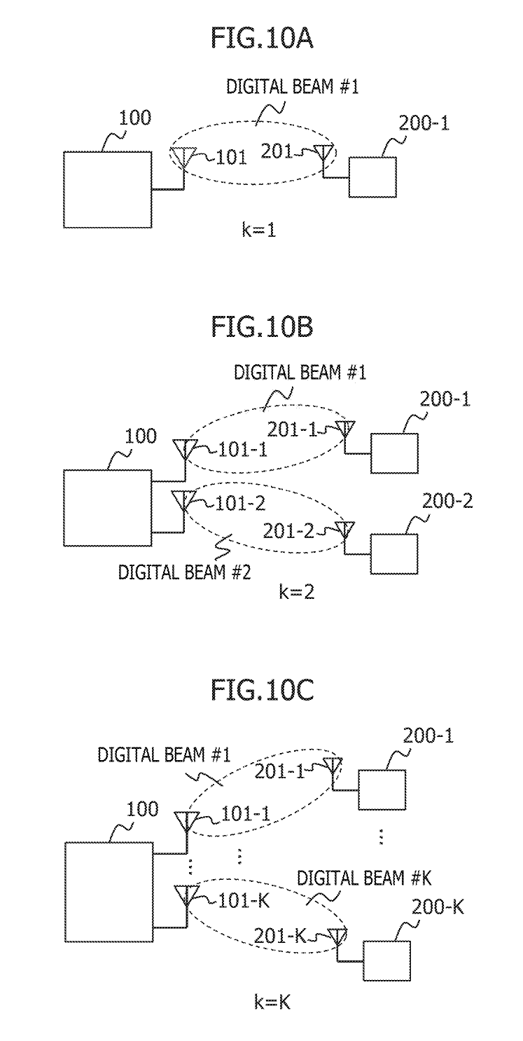

FIGS. 10A to 10C are views depicting examples of spatial multiplexing. In MIMO, for example, it is possible to allocate one stream to one antenna by digital precoding so as to perform communication with a plurality of terminals 200, in parallel, using a plurality of antennas. Where the number of terminals that may perform spatial multiplexing (hereinafter referred to sometimes as spatial multiplexing terminal number) is represented by k, in the case where k=1, the base station 100 forms one digital beam #1 using at least one antenna 101 to perform communication with one terminal 200-1. Meanwhile, in the case where k=2, the base station 100 may form two digital beams #1 and #2 simultaneously by two antennas 101-1 and 101-2 to communicate simultaneously with two terminals 200-1 and 200-2. Then, in the case where spatial multiplexing may be performed with a multiplicity of K that is the maximum value for the spatial multiplexing terminal number k, the base station 100 may form K digital beams #1 to #K simultaneously using K antennas 101-1 to 101-K to communicate simultaneously with K terminals 200-1 to 200-K. Also it is possible to consider the spatial multiplexing terminal number as the number of terminals that perform communication by using, for example, digital beams that are formed simultaneously with the digital beam #1.

It is to be noted that the digital beams #1 to #K are beams formed, by the antennas 101, using digital precoding.

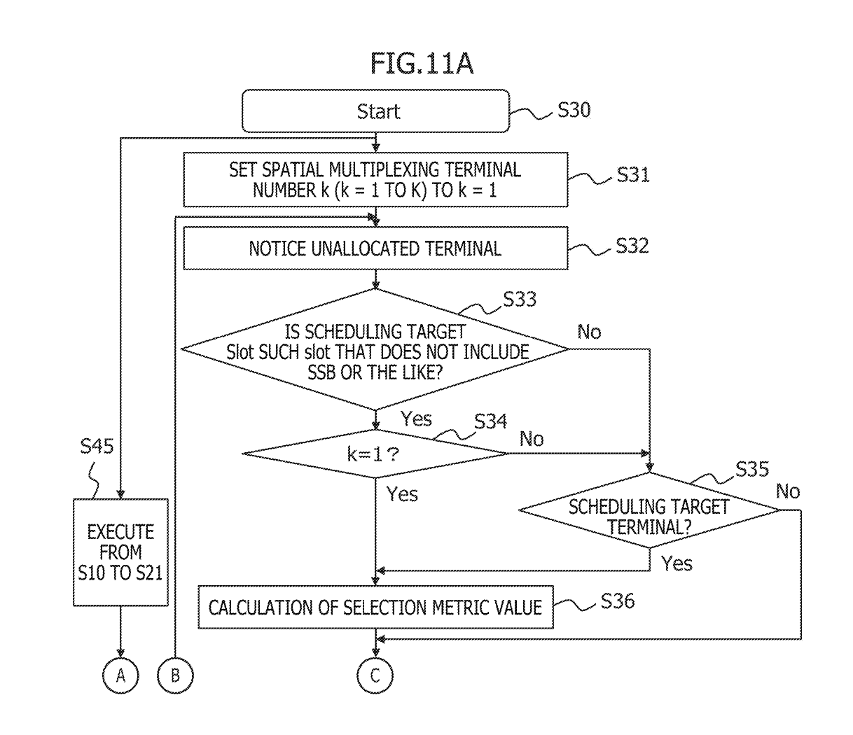

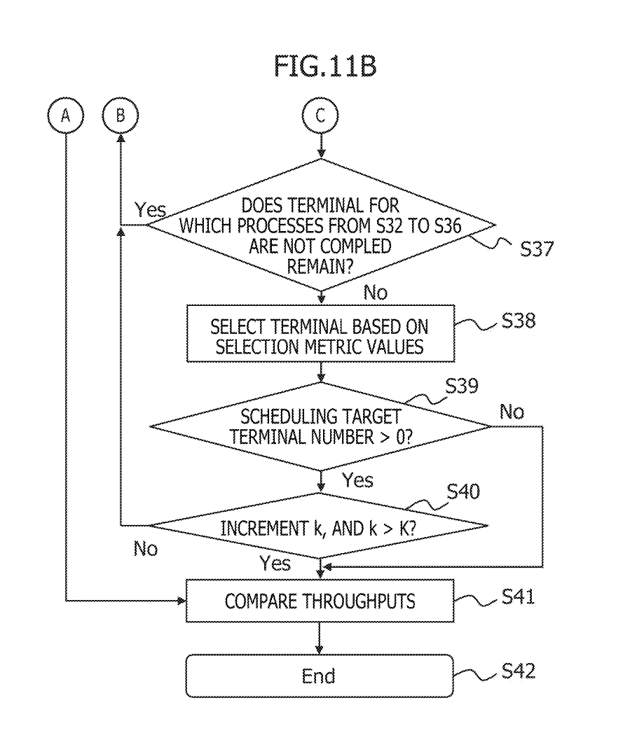

FIGS. 11A and 11B illustrate a flowchart depicting an example of operation of the second embodiment. In the present operation example, the base station 100 selects, as terminals that may perform spatial multiplexing, a plurality of (K in the maximum) terminals 200 by processes at S31 to S40. On the other hand, the base station 100 selects, as the number of terminals that may perform frequency multiplexing, a plurality of (G in the maximum) terminals 200 by the first embodiment (S10 to S21) (S45). Then, the base station 100 calculates a total throughput of the terminals 200 selected as the terminals that may perform spatial multiplexing and a total throughput of the terminals 200 selected as the terminals that may perform frequency multiplexing, and adopts the selection result that has a higher (or greater) throughput value (S41).

Note that it is assumed that, also in the present operation example, the base station 100 acquires candidate beam information and feedback information from the terminals 200 and receives also user data destined for the terminals 200 from a node apparatus.

After the base station 100 starts its processing (S30), it sets the spatial multiplexing terminal number k to k=1 (S31). For example, the scheduling unit 105 sets the spatial multiplexing terminal number k to k=1. In this case, the scheduling unit 105 calculates the maximum value K for the spatial multiplexing terminal number k, for example, based on the number N_{ANT} of the antennas 101-1 to 101-N_{ANT} and the number of terminals 200. For example, the scheduling unit 105 may determine the number of pieces of acquired feedback information as the maximum value K.

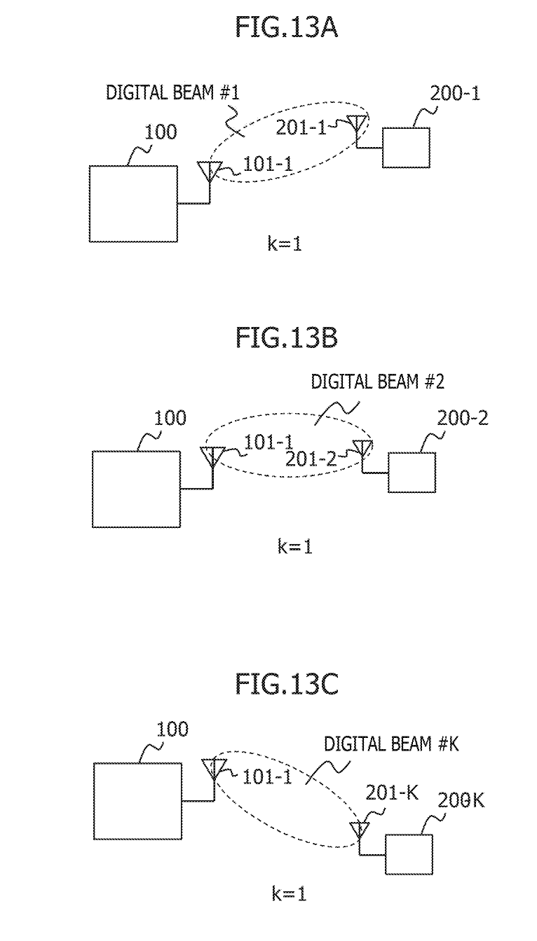

Then, the base station 100 notices an unallocated terminal (S32) and decides whether or not a scheduling target slot is a slot that does not include an SSB or the like (or a slot of the pattern (2)) (S33). Also in the second embodiment, the base station 100 decides whether the scheduling target slot is the pattern (2) or the pattern (1) similarly as in the first embodiment. In the following, description is given using examples of FIGS. 13A to 13C, and it is assumed that the scheduling unit 105 in this case determines the terminal 200-1 as an unallocated noticed terminal and the scheduling target slot is the pattern (2). Operation in the case where the scheduling target slot is the pattern (1) is described after the description of the pattern (2).

When the scheduling target slot is a slot that does not include an SSB (Yes at S33), the base station 100 decides whether or not k=1 (S34), and calculates, when k=1 (Yes at S34), the selection metric (S36).

FIGS. 13A to 13C are views depicting examples of a digital beam in the case where k=1. As depicted in FIGS. 13A to 13C, the base station 100 may form digital beams #1 to #K individually for the terminals 200-1 to 200-K. For example, the digital beam #1 is a digital beam that corresponds to PMI fed back to the base station 100 by the terminal 200-1, and the digital beam #2 is a digital beam corresponding to PMI fed back by the terminal 200-2.

In the examples of FIGS. 13A to 13C, in the case where k=1, the scheduling unit 105 calculates the selection metric value for the noticed terminal 200-1. The selection metric may be, for example, the PF norm or the round robin norm similarly as in the first embodiment.

Then, the base station 100 decides whether or not there remains a terminal for which the processes at S33 to S36 (S37) are not completed. The processes at S33 to S36 are hereinafter referred to sometimes as “second process.” When k=1, in the case where the processes at S32 to S36 are completed for all terminals 200 that are a scheduling target, the base station 100 decides that the second process is completed (No at S37), but in any other case, the base station 100 decides that the second process is not completed (Yes at S37).

In the examples of FIGS. 13A to 13C, since the processes at S32 to S36 are not completed for the terminals 200-2 to 200-K, the scheduling unit 105 makes a decision of Yes at S37. In this case, the base station 100 performs the processes at S32 to S36 by setting each of the other terminals 200-2 to 200-K as a noticed terminal. For example, when the terminal 200-2 is set as a noticed terminal, since the target slot remains the pattern (2) (Yes at S33) and also k remains k=1 without a change (Yes at S34), the scheduling unit 105 calculates the selection metric value for the terminal 200-2 (S36). Thereafter, the scheduling unit 105 repeats the processes up to S37 to calculate the selection metric value for the terminals 200-1 to 200-K.

Then, when there remains no terminal for which the processes at S33 to S36 are not completed (No at S37), the base station 100 selects a terminal 200, based on the selection metric values. For example, the scheduling unit 105 selects the terminal 200-1.

Then, when a scheduling target terminal exists, or a scheduling target terminal number representative of the number of terminals available for a scheduling target is greater than 0 (Yes at S39), the base station 100 increments the spatial multiplexing terminal number k and decides whether or not k after incremented is greater than the maximum value K (S40). When k is not greater than the maximum value K (No at S40), the base station 100 advances the processing to S32 to repeat the processes described above.

On the other hand, when a scheduling target terminal does not exist (No at S39), the base station 100 advances the processing to S41 even in the case where the spatial multiplexing terminal number k does not exceed the maximum value K.

The following description is given assuming that k=2. The base station 100 notices, for example, the terminal 200-2 as an unallocated terminal 200 (S32). It is to be noted that, since k=1 does not occur after k=2 (No at S34), the base station 100 performs a decision process for the noticed terminal 200 (S35).

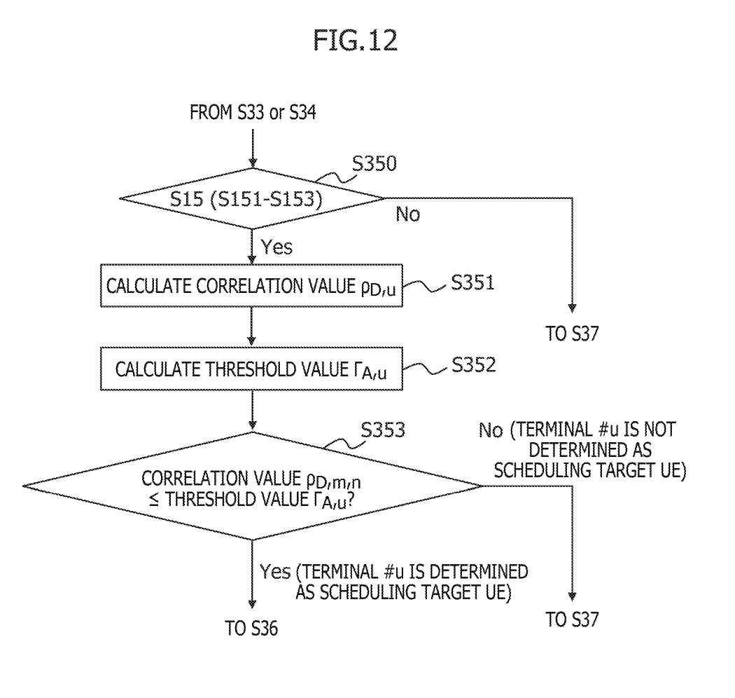

FIG. 12 is a flowchart depicting an example of the decision process (S35) for deciding whether or not the noticed terminal 200 is a scheduling target terminal.

The base station 100 first decides whether or not the noticed terminal 200 is to be subjected to the decision process (S15) applied in the first embodiment, for example, whether or not the noticed terminals 200 is a scheduling target of an analog beam (S350). For example, the base station 100 performs the following processes.

For example, the scheduling unit 105 notices the noticed terminal 200-2 in regard to the analog beam #1 (=analog beam #b=analog beam #m) that is a candidate beam for the terminal 200-1 selected with k=1. The scheduling unit 105 calculates the correlation value ρ_{A,m,n} and the threshold value ┐_{A,u} between the analog beam #m and the analog beam #2 (=analog beam #n) that is a candidate beam for the noticed terminal 200-2 (S151 and S152), and decides whether or not the correlation value ρ_{A,m,n} is equal to or greater than the threshold value ┌_{A,u} (S153). When the correlation value ρ_{A,m,n} is equal to or greater than the threshold value ┌_{A,u}, the scheduling unit 105 selects the noticed terminal 200-2 as a scheduling target terminal (Yes at S350), and performs the processes at S351 to S353 for the selected terminal 200-2. On the other hand, when the correlation value ρ_{A,m,n} is smaller than the threshold value ┌_{A,u}, the scheduling unit 105 decides that the noticed terminal 200-2 is not a scheduling target (No at S350), and thereafter advances the processing to S37.

For example, the scheduling unit 105 performs, for example, the following process at S350. For example, the scheduling unit 105 sets the selection priority degree of a terminal 200 selected when the correlation value ρ_{A,m,n} is equal to or greater than the threshold value ┌_{A,u} to a value equal to or higher than the selection priority degree threshold value, but sets the selection priority degree of a terminal 200 when the correlation value ρ_{A,m,n} is smaller than the threshold value ┌_{A,u} to a value lower than the selection priority degree threshold value. Then, the scheduling unit 105 performs the decision processes beginning with step S351 for the terminal 200 whose selection priority degree is equal to or higher than the selection priority degree threshold value.

When the base station 100 decides that the noticed terminal 200-2 is a scheduling target terminal (Yes at S350), it calculates the correlation value ρ_{D,m,n} (S351). For example, the scheduling unit 105 calculates the correlation value ρ_{D,m,n} by using the following expression:

$$\begin{matrix}[ Expression 3 ] & \\ {ρ}_{D , m , n} = {\vert \frac{{v}_{m} \cdot {v}_{n}^{H}}{‖ {v}_{m} ‖ ‖ {v}_{n} ‖} \vert}^{2} & ( 3 )\end{matrix}$$

In the expression (3), vₘ is a weight vector of the digital beam #m applied, for example, by the digital precoding unit 108. Meanwhile, vₙ is a weight vector of the digital beam #n applied by the digital precoding unit 108.

In the second embodiment, the digital beam #m is a digital beam, for example, corresponding to PMI fed back by a terminal 200 selected as a scheduling target terminal when g=1. On the other hand, the digital beam #n is a digital beam, for example, corresponding to PMI fed back by an unallocated terminal 200 (or the noticed terminal 200).

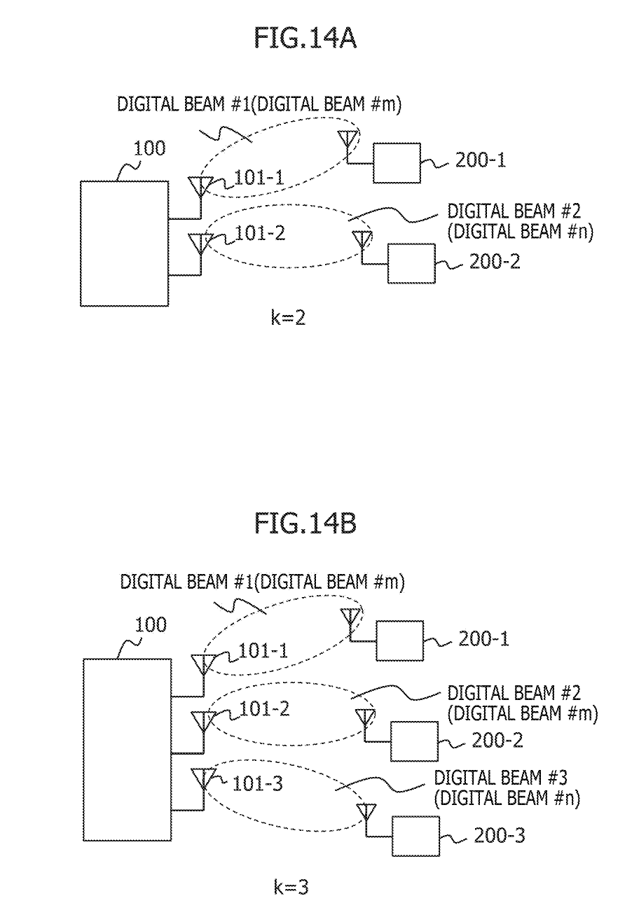

FIG. 14A is a view depicting an example of the digital beam #n when the digital beam #1 is the digital beam #m in the case where k=2. In the example of FIG. 14A, the digital beam #1 is a digital beam corresponding to PMI fed back by the terminal 200-1 selected as a scheduling target terminal and is the digital beam #m. On the other hand, the digital beam #2 corresponding to PMI fed back by an unallocated terminal 200-2 (noticed terminal 200-2) may be the digital beam #n.

In the following description, the digital beam corresponding to PMI fed back by a terminal 200 is referred to sometimes as “digital beam corresponding to the terminal 200,” and a terminal 200 having such a digital beam as just described is referred to sometimes as “terminal 200 corresponding to the digital beam.”

It is to be noted that, although, in FIG. 14A. the digital beam #2 is indicated as an example of the digital beam #n, a plurality of digital beams #n from the digital beam #2 to the digital beam #K exist.

For example, the scheduling unit 105 calculates the correlation value ρ_{D,m,n} of the digital beam #m (digital beam #1) to each digital beam #n (digital beam #2 to digital beam #K) by utilizing the expression (3). The expression (3) is retained, for example, in an internal memory of the scheduling unit 105 or the like, and the scheduling unit 105 may suitably read out and use the expression (3) for calculation. Alternatively, the scheduling unit 105 may store correlation values ρ_{D,m,n} for arbitrary combinations (m, n) into the internal memory in advance and suitably read out a correlation value ρ_{D,m,n} upon processing.

Also in the expression (3), the second term of the numerator of the right side represents an Hermitian transposed matrix of the weight vector vₙ and may be represented as the weight vector vₙ itself similarly as in the expression (1). Accordingly, the right side of the expression (3) becomes |cosθ2|² by performing calculation of the inner product. Here, θ2 represents, for example, an angle defined by two weight vectors vₘ and vₙ. It is to be noted that the two weight vectors vₘ and vₙ may be represented using a complex vector.

Referring back to FIG. 12, the base station 100 subsequently calculates the threshold value ┌_{D,u} (S352). For example, the base station 100 calculates the threshold value ┌_{D,u} by using the following expression:

[Expression 4]

┌_{D,u}=rwₖ+sw_{Ds}_{ᵤ} (4)

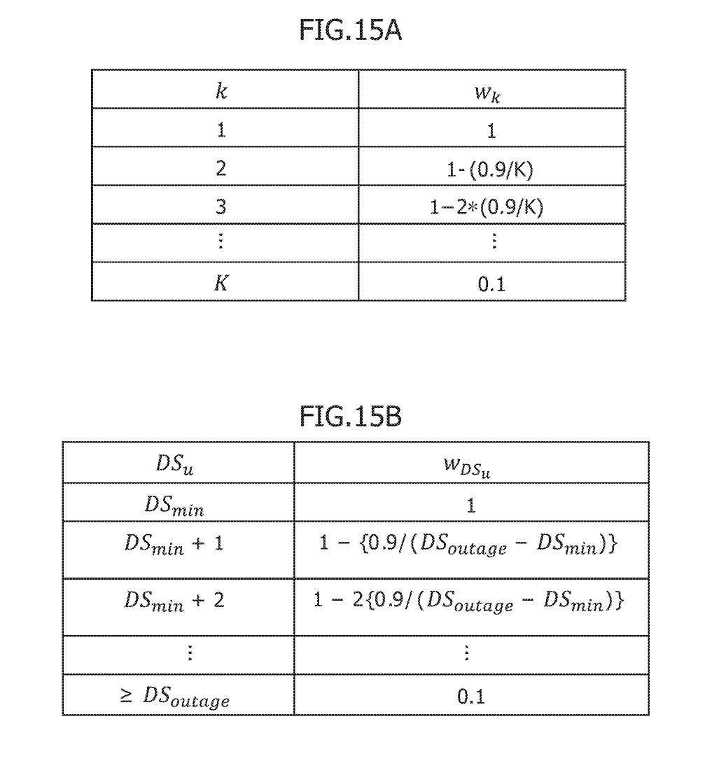

In the expression (4), wₖ represents, for example, a coefficient determined by the spatial multiplexing terminal number k. FIG. 15A is a view depicting an example of the coefficient wₖ. The coefficient wₖ is set such that it increases as the spatial multiplexing terminal number k decreases but decreases as the spatial multiplexing terminal number k increases. Alternatively, the scheduling unit 105 sets the coefficient wₖ (or the threshold value ┌_{A,u}) to a value that comes closer to “1” as the spatial multiplexing terminal number k comes closer to “1” but to a value that comes closer to “0” as the spatial multiplexing terminal number k comes closer to the maximum value K.

In the expression (4), w_{DSu} represents, for example, a coefficient determined by an index (hereinafter referred to sometimes as “delay spread”) DSᵤ representative of a delay spread of the noticed terminal 200-u. FIG. 15B is a view depicting an example of the coefficient w_{Dsu}. The coefficient w_{Dsu} is set such that it increases as the delay spread DSᵤ decreases but decreases as the delay spread DSᵤ increases. Alternatively, the scheduling unit 105 sets the coefficient w_{Dsu} (or the threshold value ┌_{D,u}) to a value closer to “1” as the delay spread DSᵤ comes closer to “0” but to a value closer to “0” as the delay spread DSᵤ comes closer to the maximum value.

Further, in the expression (4), r and s are numerical values settable by the user, and by setting one of r and s at “0,” the base station 100 may calculate the threshold value ┌_{D,u} by using one of the coefficients wₖ and w_{DSu} similarly to p and q in the first embodiment.

It is to be noted that the scheduling unit 105 may calculate the delay spread DSᵤ, for example, based on feedback information. For example, the scheduling unit 105 calculates the delay spread DSᵤ by determining a reception power value from the acquired CQI and substituting the reception power value into a specific calculation expression.

In this manner, the base station 100 may control (or change) the threshold value ┌_{D,u} for each terminal 200.

Referring back to FIG. 12, the base station 100 subsequently decides, in regard to all digital beams #m, whether or not the correlation value ρ_{D,m,n} is equal to or smaller than the threshold value ┌_{D,u} (S353). Then, when the correlation value ρ_{D,m,n} is equal to or smaller than the threshold value ┌_{D,u} (when the correlation value ρ_{D,m,n} threshold value ┌_{D,u}) in regard to all digital beam #m (Yes at S353), the base station 100 determines the noticed terminal 200-u as a terminal 200 of a scheduling target. On the other hand, when the correlation value ρ_{D,m,n} is greater than the threshold value ┌_{D,u} (when the correlation value ρ_{D,m,n}>threshold value ┌_{D,u}) in regard to some of the digital beams #m (No at S35), the base station 100 does not determine the noticed terminal 200-u as a terminal 200 of a scheduling target.

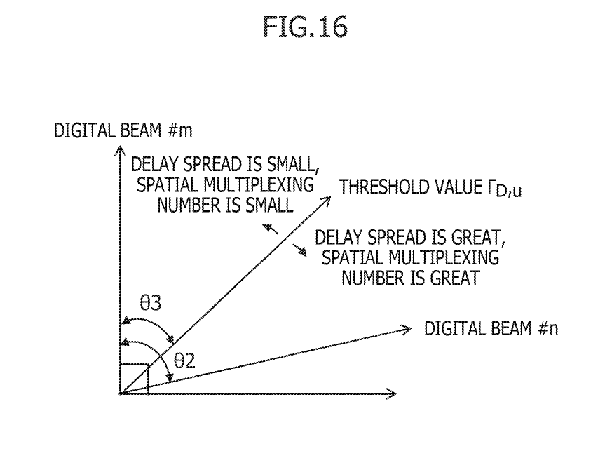

FIG. 16 is a view depicting an example of a relationship between the digital beams #m and #n and the threshold value ┌_{d,u}.

For example, when the delay spread DSᵤ is small and the spatial multiplexing terminal number k is small, the angle θ3 defined by the digital beam #m and the threshold value ┌_{D,u} gradually decreases, and in the reverse case, the angle θ3 gradually increases.

When the correlation value ρ_{D,m,n} becomes equal to or smaller than the threshold value ┌_{D,u}, the scheduling unit 105 of the base station 100 selects the noticed terminal 200-u as a terminal 200 of a scheduling target.

For example, when the digital beam #n indicates, with reference to the digital beam #m, an angle θ2 that is apart in angle from a threshold value as depicted in FIG. 16, the scheduling unit 105 selects the noticed terminal 200-u corresponding to the digital beam #n as a terminal 200 of a scheduling target. In this case, the scheduling unit 105 may, for example, spatially multiplex the digital beam #n, which is appropriate in terms of the delay spread DSᵤ and appropriate also in terms of the spatial multiplexing terminal number k, with the digital beam #m.

On the other hand, when the correlation value ρ_{D,m,n} is greater than the threshold value ┌_{D,u}, in other words, when the digital beam #n exists within a range of an angle that is smaller in angle than the threshold value ┌_{D,u} with reference to the digital beam #m, the base station 100 does not determine the noticed terminal 200-u corresponding to the digital beam #n as a scheduling target.

In this case, the noticed terminal 200-u corresponding to the digital beam #n exists within an angular range that is so close to the digital beam #m that neither the delay spread DSᵤ is appropriate nor the spatial multiplexing terminal number k is appropriate. In such a case as just described, for example, the scheduling unit 105 does not select the noticed terminal 200-u so that the digital beam #n is not spatially multiplexed with the digital beam #m.

Referring back to FIG. 12, for example, the scheduling unit 105 determines the noticed terminal 200-u as a scheduling target when the correlation value ρ_{D,m,n} calculated at S351 is equal to or smaller than the threshold value ┌_{D,u} calculated at S352 (Yes at S353). On the other hand, in any other case (No at S353), the scheduling unit 105 does not determine the noticed terminal 200-u as a scheduling target.

Referring back to FIG. 11B, the base station 100 calculates the selection metric value for a terminal 200 determined as a scheduling target (S38), and repeats the processes at S32 to S36 until an unallocated terminal 200 exists no more (No at S37). On the other hand, the base station 100 does not calculate, for a terminal 200 that is not made a scheduling target, the selection metric value and repeats the processes until an unallocated terminal 200 does not exist any more (No at S37).

When an unallocated terminal 200 does not exist any more (No at S37), the base station 100 selects a terminal 200, based on the selection metric values (S38). For example, as depicted in FIG. 14A, the base station 100 sets k to k=2, and determines the terminal 200-2 corresponding to the digital beam #2 as a scheduling target.

Thereafter, the base station 100 increments the spatial multiplexing terminal number k, and repeats the processes at S32 to S40. It is to be noted that FIG. 14B is a view depicting an example in the case where k=3 and the terminal 200-3 is selected as a scheduling target.

Referring back to FIG. 11B, when the spatial multiplexing terminal number k exceeds the maximum value K (Yes at S40) or a scheduling target terminal exists no more (Yes at S39), the base station 100 calculates all throughputs and compares the throughputs. For example, the base station 100 performs the following processes.

For example, the scheduling unit 105 calculates all throughputs of the terminal 200 selected at S38. As such throughput, the selection metric value (S36) may be utilized. Further, the scheduling unit 105 executes the processes at S10 to S21 to calculate all throughputs of the selected frequency multiplexing target terminals 200 (S18). Also in this case, for each throughput, the selection metric value (S16) may be used. Then, the scheduling unit 105 selects a terminal 200 having a higher throughput (either the terminal 200 selected for frequency multiplexing or the terminal 200 selected for spatial multiplexing).

When the terminal 200 selected for frequency multiplexing is selected, the scheduling unit 105 outputs the weighting value to the analog BF unit 102 to perform analog BF.

On the other hand, in the case where the terminal 200 selected for spatial multiplexing is selected, the scheduling unit 105 outputs a PMI representative of a result of the weighting to the digital precoding unit 108. In the example of FIG. 14B, the scheduling unit 105 outputs a PMI representative of the digital beam #1 to the antenna 101-1 and outputs a PMI representative of the digital beam #2 to the antenna 101-2. In this case, the scheduling unit 105 outputs, for example, the weighting value indicative of the digital beam #m to the analog BF unit 102 similarly as in the first embodiment. The base station 100 may perform hybrid BF by analog BF and digital precoding.

Then, the base station 100 ends the series of processes (S42).

Here, a case is described in which the base station 100 sets k to k=1 (S31) and notices the noticed terminal 200-1 and the scheduling target slot is the pattern (1) (No at S33) is described.

Also in this case, the base station 100 makes a decision of No at S33 and decides whether or not the noticed terminal 200-1 is a scheduling target terminal (S35). The base station 100 performs, for example, the following processes.

For example, the scheduling unit 105 may perform S350 by setting an analog beam formed from a slot including an SSB as the analog beam #a=analog beam #m and setting an analog beam that is a candidate beam for the terminal 200-1 as the analog beam #n. The scheduling unit 105 calculates the correlation value ρ_{A,m,n} and the threshold value ┌_{A,u} for the analog beam #m and the analog beam #n that corresponds to the noticed terminal 200-1 (S151 and S152), and decides whether or not the correlation value ρ_{A,m,n} is equal to or greater than the threshold value ┌_{A,u} (S153). When the correlation value ρ_{A, m,n} is equal to or greater than the threshold value ┐_{A,u}, the scheduling unit 105 selects the noticed terminal 200-1 as a scheduling target terminal (Yes at S350) and performs the processes at S351 to S353 for the selected terminal 200-1. On the other hand, when the correlation value ρ_{A,m,n} is smaller than the threshold value ┌_{A,u}, the scheduling unit 105 decides that the noticed terminal 200-1 is not a scheduling target (No at S350), and advances the processing to S37. Then, in the case where k=1, the scheduling unit 105 notices each of the other unallocated terminals 200-2 to 200-K to calculate the correlation value ρ_{A,m,n} and so forth from the analog beam #a=analog beam #m and the analog beam #n that is a candidate beam (S151 and S152). The scheduling unit 105 calculates the correlation value ρ_{D,m,n} and the threshold value ┌_{D,u} for each of the terminals 200-2 to 200-K with regard to which a decision of Yes has been made at S350 (S351 and S352), and decides whether or not the terminal is a scheduling target (S353).

In this manner, also in the second embodiment, the base station 100 selects a terminal 200 as a terminal, with which the base station 100 is to communicate by using the digital beam #n simultaneously with the digital beam #m, based on feedback information and the correlation value of the digital beam #n to the digital beam #m. Consequently, for example, the number of digital beams #n to be spatially multiplexed with the digital beam #m becomes an appropriate number, and improvement of the throughput may be achieved in comparison with that in an alternative case in which the number is equal to or smaller than the threshold value.

It is to be noted that the foregoing description of the second embodiment is described taking the delay spread DSᵤ as a numerical value to be used for calculation of the threshold value ┌_{D,u}. Alternatively, for example, CQIᵤ may be used similarly as in the first embodiment. The numerical values to be used for calculation of the threshold value ┌_{D,u} may be those capable of being calculated, for example, from numerical values and so forth included in feedback information.

### Third Embodiment

In the first embodiment, the base station 100 calculates the threshold value ┐_{A,u} by using the expression (2). Meanwhile, in the second embodiment, the base station 100 calculates the threshold value ┌_{D,u} by using the expression (4). In the third embodiment described below, an example is described in which antenna configuration information is used for calculation of the threshold values ┌_{A,u} and ┐_{D,u}.

The base station 100 may calculate the threshold value ┌_{A,u} by using the following expression (5) in place of the expression (2):

[Expression 5]

┌_{A,u}=pw_{N}_{_{UE,m}}+qw_{CQI}_{ᵤ}+twₐₙₜ (5)

wₐₙₜ is a coefficient determined from antenna configuration information of an antenna to be utilized to form the analog beam #m applied, for example, in a scheduling target slot. The antenna configuration information is information, for example, relating to the antennas 101-1 to 101-N_{ANT}. As the information relating to the antennas 101-1 to 101-N_{ANT}, for example, there are an antenna number indicating the number of antennas, a distance between antennas, a combination of them and so forth. In the case where an antenna number and a distance between antennas are used in combination as the antenna configuration information, for example, numerical values obtained by rounding two values including a value indicative of the number of antennas and a numerical value indicative of a distance between antennas may be used.

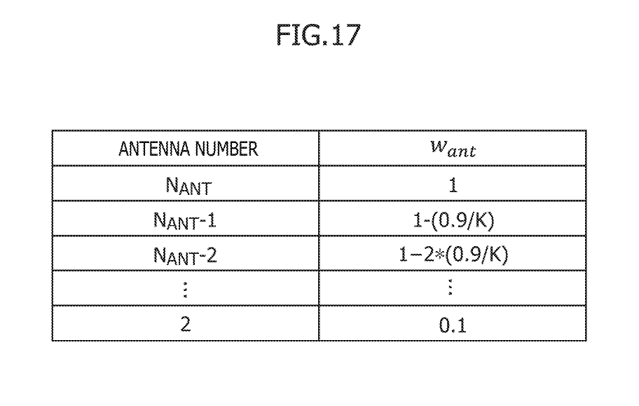

FIG. 17 is a view depicting examples of the coefficient wₐₙₜ. FIG. 17 depicts examples in which an antenna number is used as the antenna configuration information. As the antenna number Nₐₙₜ increases, also the coefficient wₐₙₜ increases, and as the antenna number Nₐₙₜ decreases, the coefficient wₐₙₜ decreases.

Similarly as in the first embodiment, the base station 100 uses the expression (5) such that, when the correlation value ρ_{A,m,n} threshold value ┌_{A,u} is satisfied, the base station 100 determines the noticed terminal 200-u as a scheduling target, but in any other case, the base station 100 does not determine the noticed terminal 200 as a scheduling target (S153 of FIG. 6).

It is to be noted that t is, for example, a weight coefficient of the coefficient wₐₙₜ and may be set at an arbitrary value by the user similarly to p and q.

Alternatively, the base station 100 may calculate the threshold value ┌_{D,u} by using the following expression (6) in place of the expression (4):

[Expression 6]

┌_{D,u}=rwₖ+sw_{DS}_{ᵤ}+xwₐₙₜ (6)

Also in this case, similarly as in the second embodiment, the base station 100 uses the expression (6) such that, when the correlation value ρ_{D,m,n}≤threshold value ┌_{D,u} is satisfied, the noticed terminal 200-u may be determined as a scheduling target, but in any other case, the noticed terminal 200-u is not determined a scheduling target (S353 of FIG. 12).

The two threshold values ┌_{A,u} and ┌_{D,u} are changeable (or controllable) for each terminal 200 to be made a target similarly as in the first and second embodiments (S152 and S352).

It is to be noted that x is, for example, a weight coefficient of the coefficient wₐₙₜ and may be set at an arbitrary value by the user.

In this manner, in the third embodiment, since antenna configuration information is further included as a factor into the threshold values ┌_{A,u} and ┌_{D,u}, appropriate threshold values ┌_{A,u} and ┌_{D,u} may be set for each terminal 200 in response to the number of antennas 101-1 to 101-N_{ANT} or the distance between the antennas 101-1 to 101-N_{ANT}.

### Other Embodiments

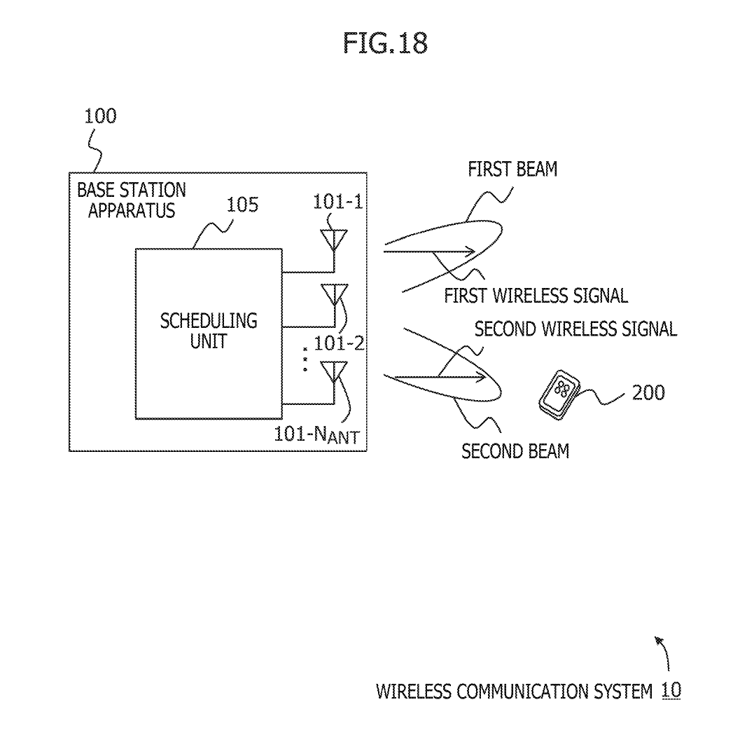

FIG. 18 is a view depicting an example of a configuration of a wireless communication system.

The wireless communication system 10 depicted in FIG. 18 includes a base station apparatus 100, and a terminal apparatus 200. The base station apparatus 100 includes a plurality of antennas 101-1 to 101-N_{ANT}, and a scheduling unit 105.

The plurality of antennas 101-1 to 101-N_{ANT} transmit first and second wireless signals to the terminal apparatus 200, and individually form first and second beams. Further, the plurality of antennas 101-1 to 101-N_{ANT} receive a third wireless signal including feedback information of the terminals 200 to the second wireless signal, from the terminal apparatus 200.

The scheduling unit 105 selects a terminal apparatus 200, to which the second beam is optimum, as a terminal that is to perform communication via the first beam, based on the feedback information and a correlation value between the first beam and the second beam. Further, the scheduling unit 105 selects, based on the feedback information and the correlation value, a terminal apparatus that is to perform communication via the second beam simultaneously via the first beam.

The plurality of antennas 101-1 to 101-N_{ANT} transmit a fourth wireless signal including data to the terminal apparatus 200, and form first and second beams.

By selecting a terminal apparatus 200 to which the second beam is optimum, as a terminal apparatus that is to perform communication via the first beam in this manner, the number of terminal apparatuses that perform communication via the first beam may be increased appropriately. Therefore, in comparison with an alternative case in which communication is performed only by a terminal apparatus to which the first beam is optimum, the base station apparatus 100 may communicate also with other terminals 200 via the first beam, and may improve the throughput.

Further, by selecting a terminal apparatus 200 as a terminal apparatus that is to perform communication via a second beam simultaneously via a first beam, the base station apparatus 100 may increase also the spatial multiplexing number appropriately. Therefore, in comparing with an alternative case in which communication is performed only via the first beam, the base station apparatus 100 may increase the number of terminal apparatuses 200 with which the base station apparatus 100 communicate simultaneously via the first beam, and may improve the throughput.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station apparatus, comprising:
a plurality of antennas configured to:
transmit, to each of a plurality of terminal apparatuses, first and second wireless signals to form first and second beams, respectively, and
receive, from each terminal apparatus, a third wireless signal including feedback information of the terminal apparatus in response to the second wireless signal;
a memory; and
a processor coupled to the memory and configured to:
select, from among the plurality of terminal apparatuses, based on the feedback information and a correlation value between the first beam and the second beam, a terminal apparatus to which the second beam is optimum, as a first terminal apparatus that performs communication via the first beam, or select a terminal apparatus as a second terminal apparatus that performs communication via the second beam while communication via the first beam is performed in parallel, wherein
the plurality of antennas transmit a fourth wireless signal including data to each terminal apparatus to form the first beam or the second beam.

2. The base station apparatus of claim 1, wherein the processor is configured to:
calculate, for each terminal apparatus, a first threshold value, based on the feedback information and a first terminal number indicating a number of terminal apparatuses that perform communication via the first beam, and
select, from among the plurality of terminal apparatuses, a terminal apparatus as the first terminal apparatus that performs communication via the first beam, based on the calculated first threshold value and the correlation value.

3. The base station apparatus of claim 2, wherein,
the processor selects, from among the plurality of terminal apparatuses, a terminal apparatus as the first terminal apparatus when the correlation value is equal to or greater than the first threshold value.

4. The base station apparatus of claim 3, wherein
the processor sets the first threshold value at a value that is closer to “0” as the first terminal number is closer to “0,” and sets the first threshold value at a value that is closer to “1” as the first terminal number is closer to a maximum value of the first terminal number.

5. The base station apparatus of claim 3, wherein:
the feedback information indicates reception quality of the plurality of terminal apparatuses; and
the processor sets the first threshold value at a value that is closer to “1” as the reception quality is closer to “0”, and sets the first threshold value at a value that is closer to “0” as the reception quality is closer to quality requested by each terminal apparatus.

6. The base station apparatus of claim 1, further comprising an analog beam forming circuit configured to control a phase of the first and second wireless signals, wherein
the processor calculates the correlation value, based on a first weight vector and a second weight vector, the first weight vector being outputted to the analog beam forming circuit and applied to the first wireless signal when the first beam is formed, the second weight vector being outputted to the analog beam forming circuit and applied to the second wireless signal when the second beam is formed, and selects, from among the plurality of terminal apparatuses, a terminal apparatus as the first terminal apparatus, based on the calculated correlation value.

7. The base station apparatus of claim 1, further comprising an analog beam forming circuit configured to control a phase of the first and second wireless signals, wherein
the first and second beams are analog beams formed by the first and second wireless signals whose phases are controlled by the analog beam forming circuit.

8. The base station apparatus of claim 1, wherein:
the plurality of antennas receive, in place of the feedback information of each terminal apparatus responsive to the second wireless signal, the feedback information of the terminal apparatus in response to the first wireless signal; and
the processor selects, from among the plurality of terminal apparatuses, a terminal apparatus as the first terminal apparatus, based on the received feedback information and the correlation value.

9. The base station apparatus of claim 1, wherein
the processor calculates, for each terminal apparatus, a second threshold value, based on the feedback information and a second terminal number indicating a number of terminal apparatuses that perform communication via beams that are formed, by the plurality of antennas, simultaneously with the first beam, and selects, from among the plurality of terminal apparatuses, a terminal apparatus as the second terminal apparatus that performs communication via the second beam, based on the second threshold value and the correlation value.

10. The base station apparatus of claim 2, wherein:
the processor sets a selection priority threshold so that a selection priority of a terminal apparatus selected when the correlation value is equal to or greater than the first threshold value is equal to or higher than the selection priority threshold, and the selection priority of a terminal apparatus selected when the correlation value is smaller than the first threshold value is smaller than the selection priority threshold;
the processor calculates, for each terminal apparatus whose selection priority is equal to or higher than the selection priority threshold, a second threshold value based on the feedback information and the number of terminal apparatuses that perform communication via the beams that are formed by the plurality of antennas simultaneously with the first beam; and
the processor selects, from among the plurality of terminal apparatuses, a terminal apparatus as the second terminal apparatus, based on the second threshold value and the correlation value.

11. The base station apparatus of claim 9, wherein
the processor selects, from among the plurality of terminal apparatuses, a terminal apparatus as the second terminal apparatus when the correlation value is equal to or smaller than the second threshold value.

12. The base station apparatus of claim 9, wherein the processor sets the second threshold value at a value that is closer to “1” as the second terminal number is closer to “1”, and sets the second threshold value at a value that is closer to “0” as the second terminal number is closer to a maximum value of the second terminal number.

13. The base station apparatus of claim 9, wherein:
the feedback information indicates reception quality of each terminal apparatus; and
the processor sets the second threshold value at a value that is closer to “1” as the reception quality is closer to “0”, and sets the second threshold value at a value that is closer to “0” as the reception quality is closer to a maximum value of the reception quality.

14. The base station apparatus of claim 1, further comprising a digital precoding circuit configured to control a phase of first data to be transmitted by the first wireless signal and second data to be transmitted by the second wireless signal, wherein
the processor calculates the correlation value, based on a third weight vector that is to be outputted, when the first beam is to be formed, to the digital precoding circuit and is to be applied to the first data, and a fourth weight vector that is to be outputted, when the second beam is to be formed, to the digital precoding circuit and is to be applied to the second data, and selects, from among the plurality of terminal apparatuses, a terminal apparatus as the second terminal apparatus, based on the calculated correlation value.

15. The base station apparatus of claim 1, further comprising a digital precoding circuit configured to control a phase of first data to be transmitted by the first wireless signal and second data to be transmitted by the second wireless signal, wherein
the first and second beams are digital beams formed from the first and second data whose phase is controlled by the digital precoding circuit.

16. The base station apparatus of claim 2, wherein
the processor calculates the first threshold value, based on the feedback information, the first terminal number, and information relating to the plurality of antennas.

17. The base station apparatus of claim 9, wherein
the processor calculates the second threshold value, based on the feedback information, the second terminal number, and information relating to the plurality of antennas.

18. The base station apparatus of claim 16, wherein
the information relating to the plurality of antennas is a number of plurality of antennas or an interval at which the plurality of antennas are positioned.

19. A scheduling method performed by a base station apparatus including a processor and a plurality of antennas, the scheduling method comprising:
transmitting, by the plurality of antennas, to each of a plurality of terminal apparatuses, first and second wireless signals to form first and second beams, respectively, and receiving, from each terminal apparatus, a third wireless signal including feedback information of the terminal apparatus in response to the second wireless signal;
selecting, by the processor, from among the plurality of terminal apparatuses, based on the feedback information and a correlation value between the first beam and the second beam, a terminal apparatus to which the second beam is optimum, as a first terminal apparatus that performs communication via the first beam, or a terminal apparatus as a second terminal apparatus that performs communication via the second beam while communication via the first beam is performed in parallel; and
transmitting, by the plurality of antennas, a fourth wireless signal including data to each terminal apparatus to form the first beam or the second beam.

20. A wireless communication system comprising:
a base station apparatus including a first processor and a plurality of antennas; and
a plurality of terminal apparatuses each including a second processor, wherein:
the plurality of antennas is configured to:
transmit, to each of the plurality of terminal apparatuses, first and second wireless signals to form first and second beams, respectively, and
receive, from each terminal apparatus, a third wireless signal including feedback information of the terminal apparatus in response to the second wireless signal;
the first processor selects, from among the plurality of terminal apparatuses, based on the feedback information and a correlation value between the first beam and the second beam, a terminal apparatus to which the second beam is optimum, as a first terminal apparatus that performs communication via the first beam, or selects a terminal apparatus as a second terminal apparatus that performs communication via the second beam while communication via the first beam is performed in parallel; and
the plurality of antennas transmit a fourth wireless signal including data to each terminal apparatus to form the first beam or the second beam.
